(19) United States
(12) Patent Application Publication
(10) Pub. No.: US 2026/0343179 A1
(43) Pub. Date: Oct. 29, 2026

(54) POSITION SIGNALING WITHIN A WIRELESS COMMUNICATION SYSTEM

(71) Applicant: Fraunhofer-Gesellschaff zur Förderung der angewandten Forschung e.V., München (DE)

(72) Inventors: Roya EBRAHIM REZAGAH, Berlin (DE); Baris GÖKTEPE, Berlin (DE); Sarun SELVANESAN, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 19/733,935

(22) Filed: Jul. 7, 2026

Related U.S. Application Data
(63) Continuation of application No. 17/703,018, filed on Mar. 24, 2022.
Application No. 17/703,018 is a continuation of application No. PCT/EP2020/076427, filed on Sep. 22, 2020.

(30) Foreign Application Priority Data
Sep. 27, 2019 (EP) 19200271.5

(51) Int. Cl. H04W 4/02; H04L 1/1812; H04W 4/40; H04W 76/14; H04W 92/18

(52) U.S. Cl. CPC H04W 4/023; H04W 76/14; H04L 1/1812; H04W 4/40; H04W 92/18

(57) ABSTRACT

A user device, UE, for a wireless communication system is described. The wireless communication system includes a plurality of user devices, UEs. The UE is to communicate with one or more further UEs using a sidelink, SL. One or more location information elements describe a location or position of a UE, wherein the location information element includes a first part and a second part, wherein, for locations or positions within a certain area, the first part of the location information element is one of a set of fixed first parts and the second part of the location information element varies dependent on the actual or exact location or position of the UE. When being in the certain area, the UE is to receive from the further UE, e.g., using sidelink control information, SCI, position information of the further UE, the position information including some or all of the second part of the location information element of the further UE, and obtain the location or position of the further UE by combining the one of the set of fixed first parts with the position information which is received from the further UE, wherein, in case the set of fixed first parts includes more than one fixed first part, the UE is to select the one of the set of fixed first parts using the position information which is received from the further UE.

### CROSS-REFERENCES TO RELATED APPLICATIONS

This application is a continuation of copending U.S. application Ser. No. 17/703,018, filed Mar. 24, 2022, which in turn is a continuation of copending International Application No. PCT/EP2020/076427, filed Sep. 22, 2020, and additionally claims priority from European Application No. EP 19 200 271.5, filed Sep. 27, 2019, all of which are incorporated herein by reference in their entirety.

### TECHNICAL FIELD

The present application relates to the field of wireless communication systems or networks, more specifically to enhancements or improvements regarding the signaling of a location or position of a user device communicating with one or more further user devices using a sidelink, SL. Embodiments of the present invention concern the signaling of a location or a position of a user device being a member a group of UEs communicating over the sidelink.

### BACKGROUND OF THE INVENTION

FIGS. 1A-1B are a schematic representation of an example of a terrestrial wireless network 100 including, as is shown in FIG. 1A, a core network 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1B by the arrows pointing to “core”. The core network 102 may be connected to one or more external networks. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device (D2D) communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and one or more of a system information block (SIB), the physical downlink, uplink and sidelink control channels (PDCCH, PUCCH, PSSCH) carrying for example the downlink control information (DCI), the uplink control information (UCI) and the sidelink control information (SCI). Note, the sidelink interface may a support 2-stage SCI. This refers to a first control region containing some parts of the SCI, and optionally, a second control region, which contains a second part of control information.

For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIGS. 1A-1B may be a heterogeneous network having distinct overlaid networks, e.g., a network of macro cells with each macro cell including a macro base station, like base station gNB₁ to gNB₅, and a network of small cell base stations (not shown in FIGS. 1A-1B), like femto or pico base stations.

In addition to the above described terrestrial wireless network also non-terrestrial wireless communication networks (NTN) exist including spaceborne transceivers, like satellites, and/or airborne transceivers, like unmanned aircraft systems. The non-terrestrial wireless communication network or system may operate in a similar way as the terrestrial system described above with reference to FIGS. 1A-1B, for example in accordance with the LTE-Advanced Pro standard or the 5G or NR, new radio, standard.

It is noted that the information in the above section is only for enhancing the understanding of the background of the invention and therefore it may contain information that does not form conventional technology that is already known to a person of ordinary skill in the art.

### SUMMARY

An embodiment may have a user device, UE, for a wireless communication system, the wireless communication system comprising a plurality of user devices, UEs, wherein the UE is to communicate with one or more further UEs using a sidelink, SL, wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE, and wherein, when being in the certain area, the UE is to receive from the further UE, e.g., using sidelink control information, SCI, position information of the further UE, the position information comprising some or all of the second part of the location information element of the further UE, and acquire the location or position of the further UE by combining the one of the set of fixed first parts with the position information which is received from the further UE, wherein, in case the set of fixed first parts comprises more than one fixed first part, the UE is to select the one of the set of fixed first parts using the position information which is received from the further UE.

Another embodiment may have a user device, UE, for a wireless communication system, the wireless communication system comprising a plurality of user devices, UEs, wherein the UE is to communicate with one or more further UEs using a sidelink, SL, wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE, and wherein, when being in the certain area, the UE is to transmit to the further UE, e.g., using sidelink control information, SCI, position information of the UE, the position information comprising some or all of the second part of the location information element of the UE.

Another embodiment may have user device, UE, for a wireless communication system, the wireless communication system comprising a plurality of user devices, UEs, wherein the UE is to communicate with one or more further UEs using a sidelink, SL, wherein, when being in the certain zone, the UE is to receive from a further UE located in the same zone or in a different zone, e.g., using sidelink control information, SCI, a zone ID and location information of the further UE, the location information indicating the position of the further UE within the zone in which the further UE is located, and acquire the location or position of the further UE using the location of the UE and the received zone ID and location information of the further UE.

Another embodiment may have user device, UE, for a wireless communication system, the wireless communication system comprising a plurality of user devices, UEs, wherein the UE is to communicate with one or more further UEs using a sidelink, SL, wherein, when being in the certain zone, the UE is to transmit to a further UE located in the same zone or in a different zone, e.g., using sidelink control information, SCI, a zone ID and location information of the UE, the location information indicating the position of the UE within the certain zone.

Another embodiment may have user device, UE, for a wireless communication system, the wireless communication system comprising a plurality of user devices, UEs, wherein the UE is to communicate with one or more further UEs using a sidelink, wherein one or more location information elements describe a location or position of a UE, and wherein, when being in a certain area, the UE is to receive at a certain time, e.g., when setting up the SL communication, from the further UE the one or more location information elements comprising the location information of the further UE, and receive at one or more times following the certain time from the further UE further location information indicating a difference between a current location of the further UE and the location signaled at the certain time.

Another embodiment may have user device, UE, for a wireless communication system, the wireless communication system comprising a plurality of user devices, UEs, wherein the UE is to communicate with one or more further UEs using a sidelink, wherein one or more location information elements describe a location or position of a UE, and wherein, when being in a certain area, the UE is to transmit at a certain time, e.g., when setting up the SL communication, to the further UE the one or more location information elements comprising the location information of the UE, and transmit at one or more times following the certain time to the further UE further location information indicating a difference between a current location of the UE and the location signaled at the certain time.

Another embodiment may have a wireless communication system, comprising a plurality of user devices, UEs, according to the invention and configured for a sidelink communication using, for example resources from a set of sidelink resources of the wireless communication system.

Another embodiment may have a method for acquiring a location or position of a user device, UE in a wireless communication, the wireless communication system comprising a plurality of user devices, UEs, the method havin the steps of: performing a communicating among a UE and one or more further UEs using a sidelink, SL, wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE, receiving from the further UE, e.g., using sidelink control information, SCI, position information of the further UE, the position information comprising some or all of the second part of the location information element of the further UE, and acquiring the location or position of the further UE by combining the one of the set of fixed first parts with the position information which is received from the further UE, wherein, in case the set of fixed first parts comprises more than one fixed first part, the UE is to select the one of the set of fixed first parts using the position information which is received from the further UE.

Another embodiment may have a method for providing a location or position of a user device, UE in a wireless communication, the wireless communication system comprising a plurality of user devices, UEs, the method havin the steps of: performing a communicating among a UE and one or more further UEs using a sidelink, SL, wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE, and transmitting from the UE to a further UE, e.g., using sidelink control information, SCI, position information of the UE, the position information comprising some or all of the second part of the location information element of the UE.

Another embodiment may have a method for acquiring a location or position of a user device, UE in a wireless communication, the wireless communication system comprising a plurality of user devices, UEs, the method havin the steps of: performing a communicating among a UE and one or more further UEs using a sidelink, SL, receiving from a further UE located in the same zone or in a different zone, e.g., using sidelink control information, SCI, a zone ID and location information of the further UE, the location information indicating the position of the further UE within the zone in which the further UE is located, and acquiring the location or position of the further UE using the location of the UE and the received zone ID and location information of the further UE.

Another embodiment may have a method for providing a location or position of a user device, UE in a wireless communication, the wireless communication system comprising a plurality of user devices, UEs, the method havin the steps of: performing a communicating among a UE and one or more further UEs using a sidelink, SL, when being in a certain zone, transmitting from the UE to a further UE located in the same zone or in a different zone, e.g., using sidelink control information, SCI, a zone ID and location information of the UE, the location information indicating the position of the UE within the certain zone.

Another embodiment may have a method for providing a location or position of a user device, UE in a wireless communication, the wireless communication system comprising a plurality of user devices, UEs, the method havin the steps of: performing a communicating among a UE and one or more further UEs using a sidelink, SL, wherein one or more location information elements describe a location or position of a UE, receiving at a certain time, e.g., when setting up the SL communication, from the further UE the one or more location information elements comprising the location information of the further UE, and receiving at one or more times following the certain time from the further UE further location information indicating a difference between a current location of the further UE and the location signaled at the certain time.

Another embodiment may have a method for providing a location or position of a user device, UE in a wireless communication, the wireless communication system comprising a plurality of user devices, UEs, the method havin the steps of: performing a communicating among a UE and one or more further UEs using a sidelink, SL, wherein one or more location information elements describe a location or position of a UE, and transmitting at a certain time, e.g., when setting up the SL communication, to the further UE the one or more location information elements comprising the location information of the UE, and transmitting at one or more times following the certain time to the further UE further location information indicating a difference between a current location of the UE and the location signaled at the certain time.

Another embodiment may have a non-transitory digital storage medium having a computer program stored thereon to perform the inventive methods, when said computer program is run by a computer.

### BRIEF DESCRIPTION OF THE DRAWINGS

Embodiments of the present invention will be detailed subsequently referring to the appended drawings, in which:

FIGS. 1A and 1B show a schematic representation of an example of a wireless communication system;

FIG. 2 illustrates a location information field in RRC in LTE as described in 3GPP TS 36.331 (see Reference [1]);

FIG. 3 illustrates a point as defined by the two coordinates in accordance with 3GPP TS 23.032 (see Reference [2]);

FIG. 4 describes an uncertainty circle according to Reference [2];

FIG. 5 describes an uncertainty ellipse according to Reference [2];

FIG. 6 describes an ellipsoid point with altitude according to Reference [2];

FIG. 7 describes an ellipsoid point with altitude and uncertainty ellipsoid according to Reference [2];

FIG. 8 illustrates the information element EllipsoidArc which describes a geographical location as an ellipsoid point in accordance with 3GPP TS 36.355 (see Reference [3]);

FIG. 9 is a schematic representation of a cell, like a cell in the network of FIGS. 1A-1B, having a coverage area divided into a plurality of zones;

FIG. 10 is a schematic representation of a wireless communication system including a transmitter, like a base station, and one or more receivers, like user devices, UEs;

FIG. 11 illustrates schematically a location information element including M bits;

FIG. 12 illustrates an embodiment in accordance with which the location IE of a transmitting UE is deduced using the location IE of a receiving UE and a received part of the location IE of the TX UE;

FIG. 13 shows an embodiment of the first aspect of the present invention employed at a street junction at which two roads intersect;

FIGS. 14A and 14B illustrate a further embodiment of the first aspect of the present invention employed for a platooning application;

FIGS. 15A, 15B, and 15C illustrate an embodiment for determining whether a minimum required communication range is met for a communication between a transmitting UE and a receiving UE;

FIGS. 16A and 16B illustrate embodiments of the present invention employing a zone concept for obtaining the location of a transmitting UE; and

FIG. 17 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

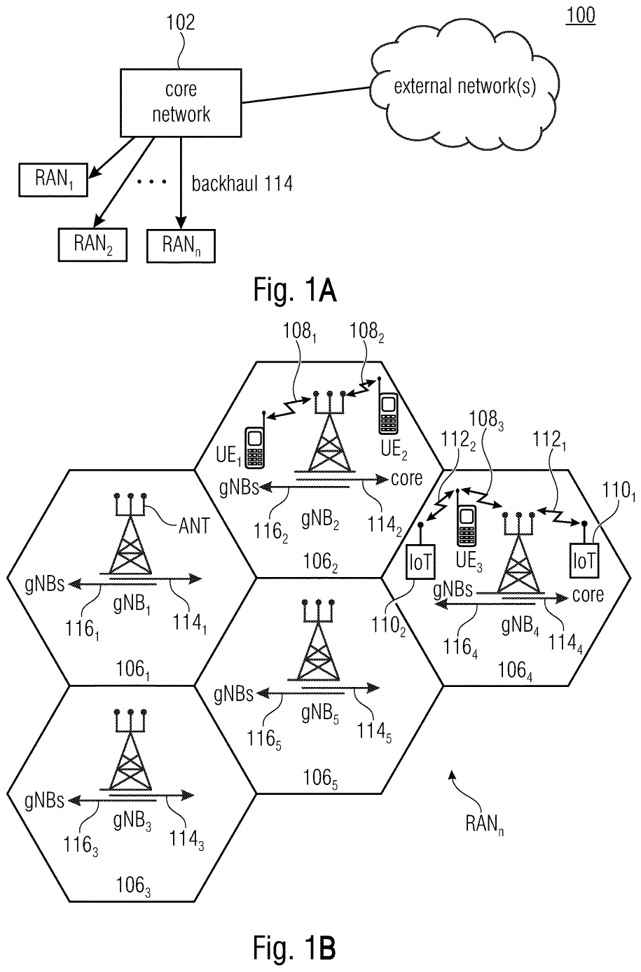

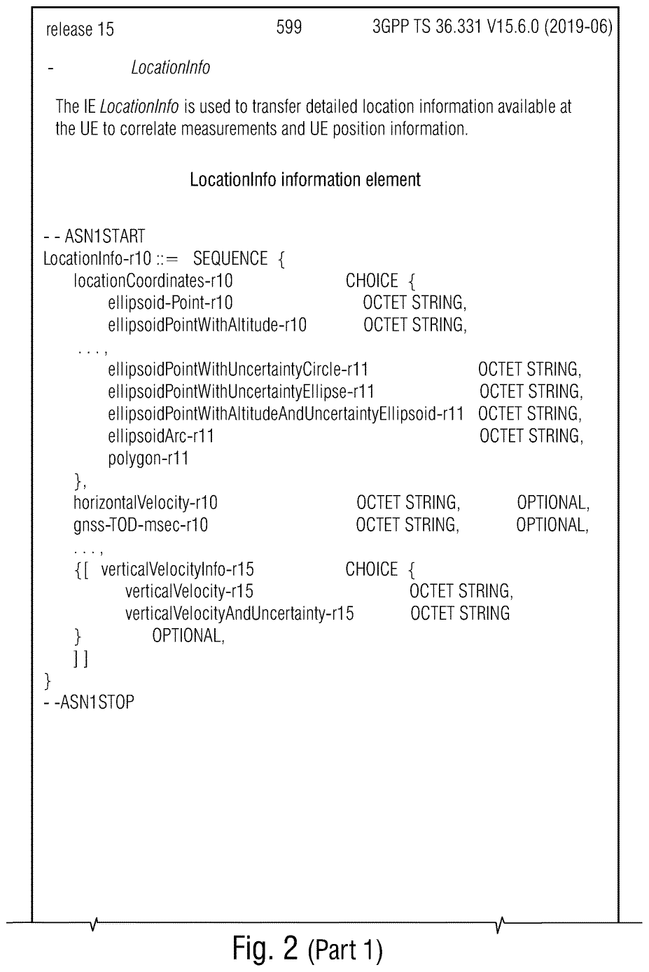

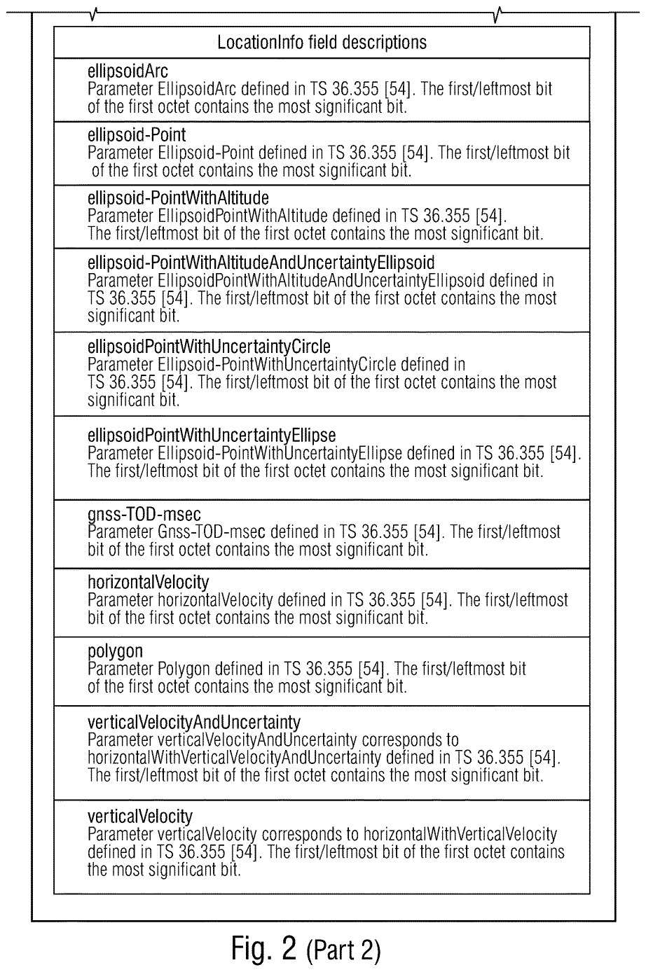

In a wireless communication system or network, like the one described above with reference to FIGS. 1A-1B, location information of a user device, UE, may be transmitted as measurement information elements within a radio resource control, RRC, measurement report, as described, for example for LTE, in 3GPP TS 36.331(see Reference [1]). FIG. 2 illustrates a location information field in RRC in as described in Reference [1]. The location is described as ellipsoid point coordinates and according to 3GPP TS 23.032 (see Reference [2]) the description of an ellipsoid point is that of a point on the surface of the ellipsoid and includes the latitude and the longitude. In practice, such a description may be used to refer to a point on the Earth's surface or close to the Earth's surface, with the same longitude and latitude.

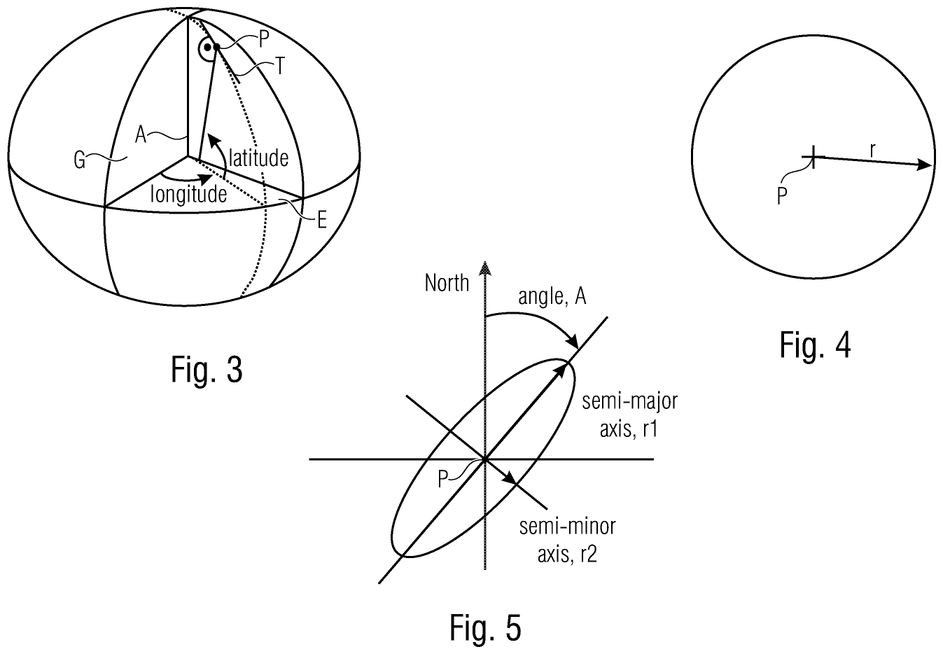

FIG. 3 illustrates a point as defined by the two coordinates defined by Reference [2]. More specifically, FIG. 3 illustrates a point P on the surface of the ellipsoid or earth E and its coordinates. The latitude is the angle between the equatorial plane A and a plane perpendicular to the tangent T on the ellipsoid surface at the point P. Positive latitudes correspond to the northern hemisphere, while negative latitudes correspond to the southern hemisphere. The longitude is the angle between the half plane G determined by the Greenwich meridian and the half-plane defined by the point P and the polar axis A, measured eastward.

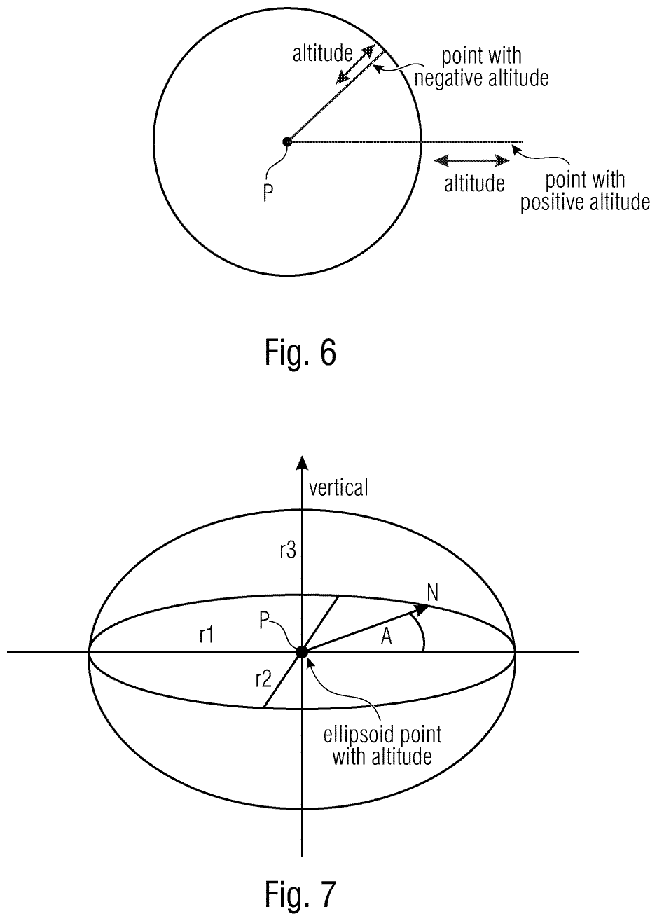

In FIG. 2, according to Reference [2], the following further elements may be defined as follows:
the “ellipsoid point with uncertainty circle” is defined by the coordinates of an ellipsoid point P, the origin and a distance r, as is illustrated in FIG. 4 describing an uncertainty circle according to reference [2],
the “ellipsoid point with uncertainty ellipse” is defined by the coordinates of an ellipsoid point P, the origin, distances r1 and r2 and an angle of orientation A as is illustrated in FIG. 5 describing an uncertainty ellipse according to reference [2],
the “high accuracy ellipsoid point with uncertainty ellipse”—compared to the “ellipsoid point P with uncertainty ellipse”, the “high accuracy ellipsoid point with uncertainty ellipse” provides a finer resolution for the coordinates, and the distances r1 and r2,
the “ellipsoid point with altitude” is defined as a point at a specified distance above or below a point P on the earth's surface; this is defined by an ellipsoid point with the given longitude and latitude and the altitude above or below the ellipsoid point as is illustrated in FIG. 6 describing an ellipsoid point with altitude according to reference [2],
the “ellipsoid point with altitude and uncertainty ellipsoid” is defined by the coordinates of an ellipsoid point P with an altitude, the distances r1 (the “semi-major uncertainty”), r2 (the “semi-minor uncertainty”) and r3 (the “vertical uncertainty”) and an angle of orientation A (the “angle of the major axis”) as is illustrated in FIG. 7 describing an ellipsoid point with altitude and uncertainty ellipsoid according to reference [2],
the “high accuracy ellipsoid point with altitude and uncertainty ellipsoid”—compared to the “ellipsoid point with altitude and uncertainty ellipsoid”, the “high accuracy ellipsoid point with altitude and uncertainty ellipsoid” provides a finer resolution for the co-ordinates, and distances r1, r2, and r3.

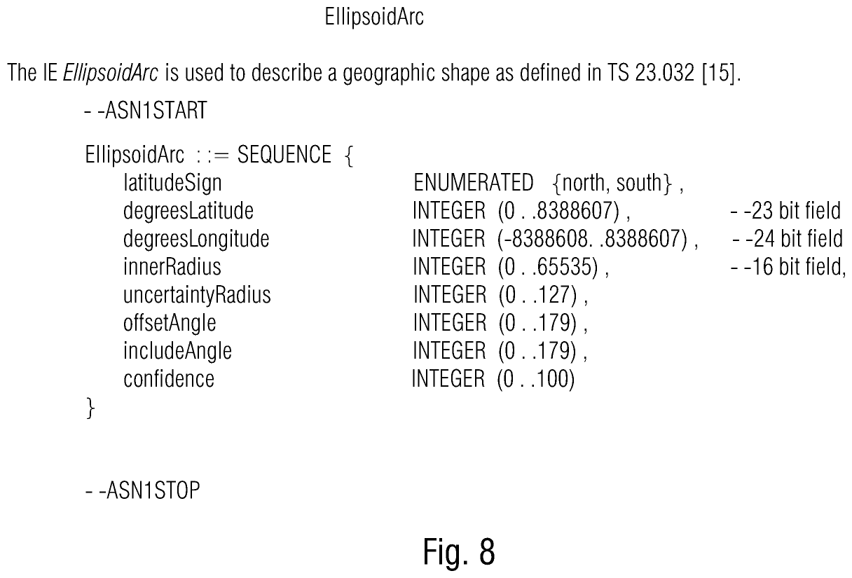

FIG. 8 illustrates the information element (IE) EllipsoidArc which describes a geographical location as an ellipsoid point in accordance with Reference [3]. Further, the above elements, namely ellipsoid point with uncertainty circle, ellipsoid point with uncertainty ellipse, high accuracy ellipsoid point with anti-ellipse, ellipsoid point with altitude, ellipsoid point with altitude and uncertainty ellipsoid, and high accuracy ellipsoid point with altitude and uncertainty ellipsoid may be employed. For these elements, the number of required bits is larger than the number of the bits for the information element EllipsoidArc.

In the following, the number of required bits for each information element, IE, is described according to Reference [2]. In accordance with reference [2], the coordinates of an ellipsoid point are coded with an uncertainty of less than 3 meters. The latitude is coded with 24 bits, namely 1 bit of sign and a number between 0 and 2²³−1 coded in binary on 23 bits. The relation between the coded number N and the range of absolute latitude X it encodes is as follows, with X in degrees:

$$N \leq \frac{{2}^{23}}{90} X < N + 1 \qquad ( 1 )$$

except for N=2²³−1, for which the range is extended to include N+1.

The longitude, expressed in the range of −180° to +180°, is coded as a number between −2²³ and +2²³−1, coded in 2's compliment binary on 24 bits. The relation between the coded number N and the range of longitude X it encodes is as follows, with X in degrees:

$$N \leq \frac{{2}^{24}}{360} X < N + 1 \qquad ( 2 )$$

In accordance with Reference [2], the coordinates of a high accuracy ellipsoid point are coded with a resolution of less than 5 millimeters for latitude and less than 10 millimeters for longitude.

The latitude for a high accuracy point, expressed in the range of −90° to +90°, is coded as a number between −2³¹ and +2³¹−1, coded in 2's complimentary binary on 32 bits. The relation between the latitude X in the range [−90°, 90° ] and the coded number N is as follows:

$$N = ⌊ \frac{X}{90 °} {2}^{31} ⌋ \qquad ( 3 )$$

where └ ┘ denotes the greatest integer less than or equal to x (floor operator).

The longitude for a high accuracy point, expressed in the range from −180° to +180°, is coded as a number between −2³¹ to +2³¹−1, coded in 2's compliment binary on 32 bits. The relation between the longitude X in the range [−180°, 180° ] and the coded number N is as follows:

$$N = ⌊ \frac{X}{180 °} {2}^{31} ⌋ \qquad ( 4 )$$

In accordance with equation (5) the uncertainty r expressed in meters, is mapped to a number K as follows:

r=C((1+x)^{K}−1) (5)

with C=10 and x=0.1. When selecting 0≤ to K≤127 a useful range between 0 and 1800 kilometers may be achieved for the uncertainty, while still allowing to code down to values as small as 1 meter. The uncertainty may then be coded with 7 bits, as the binary encoding of K.

In a wireless communication system or network, as described, for example, above with reference to FIGS. 1A-1B, user devices may communicate over the sidelink using, for example, the PC5 interface. Use cases for such sidelink communications include, for example, V2V, V2X, D2D communications, and for such sidelink communications, user devices may be grouped into one or more respective groups. For example, in accordance with Reference [4] in a V2X groupcast it may be desired to transmit the position of a transmitting UE, TX UE, to the one or more receiving UEs, RX UEs. The location of the TX UE may be indicated via the sidelink control information, SCI. SCI signaling is a method on the physical layer, while RRC signaling is sent on the MAC layer. SCI signaling is more frequent and faster, but also requires more bits since it is encoded very robust. RRC signaling on the other hand may be scheduled into the data channel, for example the physical sidelink shared channel, PSSCH, and may not have to be transmitted in every radio frame. Also, it may be sent with a higher MCS and thus in a more efficient way.

Since the SCI is sent frequently, for example it may be included in every sidelink radio frame, the overall size of the SCI is critical and the number of bits used for the SCI is designed to be as small as possible. Contrary thereto, as described above, the position information provided in accordance with References [3] and [2], that may be sent in a measurement report, requires a large number of bits, for example at least 2×24 bits for an ellipsoid point. Thus, signaling the above referenced location information requires a high number of bits to be included into the SCI when indicating the position of a transmitting UE to one or more receiving UEs communicating over sidelink and being, for example, members of a V2X group. This signaling overhead may be undesired, for example, because the number of resources that may be used for physical layer control signaling, is limited. This is because SCIs are broadcast transmissions which are meant to be received by all UEs in the vicinity. Hence, a very low modulation order and coding rate, MCS, is employed to encode SCIs. A large overhead in SCIs may degrade the overall system efficiency significantly.

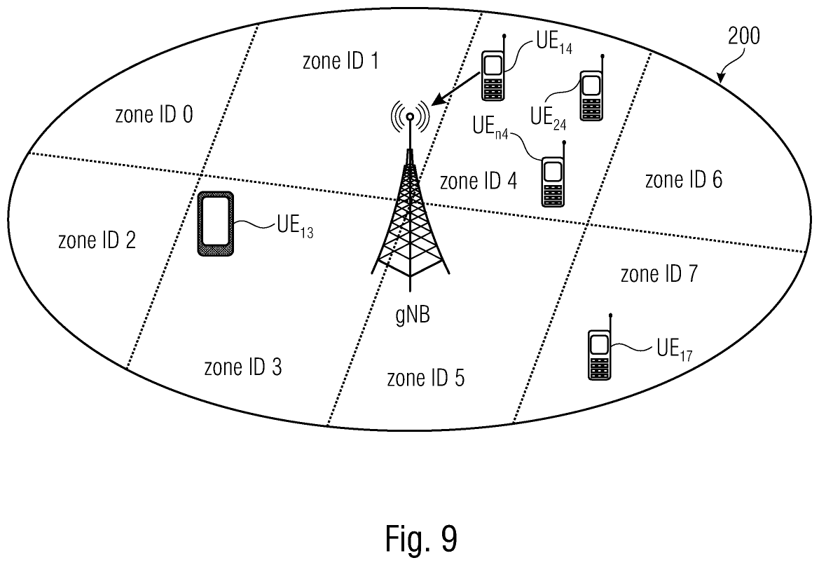

Another approach for signaling a position of a user device employs the concept of zone IDs in accordance with which a certain area is subdivided into a plurality of zones each having associated therewith a zone ID. FIG. 9 is a schematic representation of a cell, like a cell in the network described above with reference to FIGS. 1A-1B. The cell is defined by the coverage 200 of the base station gNB. The coverage area 200 is divided into a plurality of zones, each zone having associated therewith a respective zone ID. The coverage area 200 is subdivided into eight zones having assigned thereto the zone identifiers zone ID 0 to zone ID 7. It is noted that FIG. 9 is only an example of how the coverage area 200 may be separated into the respective zones, and in other examples more or less zones and zones of other shapes may be defined. The respective zones may be defined in relation to respective latitude and longitude coordinates, and the zones may also be referred to as V2X zones in scenarios in which V2X communications are to be implemented.

In accordance with other examples the zones may be defined for an area different from the coverage of one base station. For examples, the following areas may be divided into a plurality of zones:
coverage areas of a plurality of base stations of a wireless communication network or system,
a part or all of an area covered by a wireless communication network or system,
a certain geographical area on the earth, e.g., independent of a wireless communication network or system,
the entire surface of the earth.

The zone ID may be represented by a small number of bits so that signaling the zone within which a transmitting UE is located does not cause a significant signaling overhead on the side link, i.e., it may be signaled with a low number of bits. However, while the signaling overhead on the sidelink or in the SCI is reduced, the drawback is that the accuracy is low, dependent on the actual area covered by the zone associated with a certain ID. Thus, the location or position as signaled using the zone ID may be not sufficient for certain scenarios, for example in a V2X scenario the uncertainty of the position may cause the following problems. In certain scenarios, such as a junction scenario, where V2X UEs meet at a junction and V2X communication is used to coordinate the movement of V2X UEs, an accurate positioning of UEs is critical to avoid clashes during crossing the junction. In another example, some V2X UEs may be moving in a platoon and an insufficient accuracy may cause issues to track the movements of other V2X UEs in the platoon. For example, if a V2X UE accidentally took a parallel road to the high way, it may not realize that it came off the track.

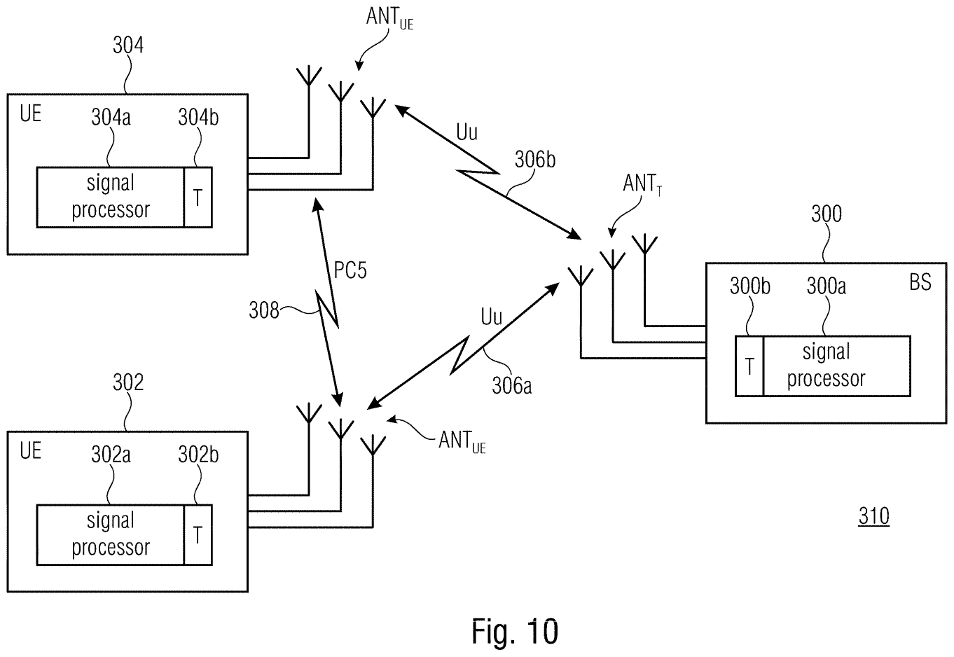

The present invention provides improvements and enhancements in a wireless communication system or network addressing the above described problems with the signaling of information of a the location or a position of a user device to one or more further user devices over a sidelink. More specifically, embodiments of the present invention avoid the signaling overhead for providing the location information or position information while still providing the actual location/position with a desired accuracy. Embodiments of the present invention may be implemented in a wireless communication system as depicted in FIGS. 1A-1B including base stations and users, like mobile terminals or IoT devices. FIG. 10 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink (SL) interface. When the UEs are not served by the base station, are not be connected to a base station, for example, they are not in an RRC connected state, or, more generally, when no SL resource allocation configuration or assistance is provided by a base station, the UEs may communicate with each other over the sidelink (SL). The system or network of FIG. 3, the one or more UEs 302, 304 and the base stations 300 may operate in accordance with the inventive teachings described herein.

### User Devices

The present invention provides (see for example claim 1) a user device, UE, for a wireless communication system, the wireless communication system including a plurality of user devices, UEs,
wherein the UE is to communicate with one or more further UEs using a sidelink, SL,
wherein one or more location information elements describe a location or position of a UE, wherein the location information element includes a first part and a second part, wherein, for locations or positions within a certain area, the first part of the location information element is one of a set of fixed first parts and the second part of the location information element varies dependent on the actual or exact location or position of the UE, and
wherein, when being in the certain area, the UE is to
   receive from the further UE, e.g., using sidelink control information, SCI, position information of the further UE, the position information including some or all of the second part of the location information element of the further UE, and
   obtain the location or position of the further UE by combining the one of the set of fixed first parts with the position information which is received from the further UE, wherein, in case the set of fixed first parts includes more than one fixed first part, the UE is to select the one of the set of fixed first parts using the position information which is received from the further UE.

In accordance with embodiments (see for example claim 2), in case the set of fixed first parts includes only one fixed or common first part, the UE is to obtain the location or position of the further UE by replacing in the UE's location information element the second part by the position information which is received from the further UE.

In accordance with embodiments (see for example claim 3), in case the set of fixed first parts includes more than one first parts, the UE is to select a first part out of the set of first parts based on an association which maps different subsets of the position information which may be received, to a different first part out of the set of first parts.

In accordance with embodiments (see for example claim 4), the user device is configured with the association which explicitly indicates the subsets and their respective associated first part out of the set of first parts, by the network, a further UE or an application, or is preconfigured.

In accordance with embodiments (see for example claim 5), the association may be determined by the UE, e.g. the UE combines the position information which is received from the further UE with all different first parts out of the set of first parts and selects the first part which results to a position that is closest to its own position.

In accordance with embodiments (see for example claim 6), the set of fixed first parts is to be updated dynamically, e.g. in case of a platoon.

In accordance with embodiments (see for example claim 7), the UE is to determine a distance to the further UE using the location of the UE and the location of the further UE.

In accordance with embodiments (see for example claim 8), dependent on a minimum required communication range, the UE is to decide whether a certain operation is to be performed, e.g., whether a HARQ feedback is to be transmitted or not to the further UE.

In accordance with embodiments (see for example claim 9), the UE is to
determine an area of minimum required communication range around the UE,
estimate an area of uncertainty around the further UE, dependent on the amount of the second part of the location information element received, and
determine whether the further UE is within the minimum required communication range or not using the area of uncertainty around the further UE and the area of minimum required communication range.

In accordance with embodiments (see for example claim 10), the UE is to
determine an area of minimum required communication range around the UE, and
determine whether the further UE is within the minimum required communication range or not.

In accordance with embodiments (see for example claim 11), the UE is to determine that the further UE is within the minimum required communication range in case one out of the following criteria is met:
the whole area of uncertainty is within the area of minimum required communication range,
at least a certain portion of the area of uncertainty is within the area of minimum required communication range,
the area of uncertainty and the area of minimum required communication range meet at least in one point.

In accordance with embodiments (see for example claim 12), to determine that the further UE is within the minimum required communication range, in case at least a portion of the area of uncertainty is within the area of minimum required communication range, the UE is to decide whether the portion of the area of uncertainty being within the area of minimum required communication range meets a certain condition, e.g., a pre-configured or configured threshold indicting an absolute size of the portion or a size of the portion relative to the area of uncertainty, like a percentage.

The present invention provides (see for example claim 13) a user device, UE, for a wireless communication system, the wireless communication system including a plurality of user devices, UEs,
wherein the UE is to communicate with one or more further UEs using a sidelink, SL,
wherein one or more location information elements describe a location or position of a UE, wherein the location information element includes a first part and a second part, wherein, for locations or positions within a certain area, the first part of the location information element is one of a set of fixed first parts and the second part of the location information element varies dependent on the actual or exact location or position of the UE, and
wherein, when being in the certain area, the UE is to transmit to the further UE, e.g., using sidelink control information, SCI, position information of the UE, the position information including some or all of the second part of the location information element of the UE.

In accordance with embodiments (see for example claim 14), the UE is a receiving UE or a transmitting UE in the SL communication.

In accordance with embodiments (see for example claim 15),
the UE is configured with the certain area, e.g., by a signaling during a group setup or a signaling from a network entity, like a RSU, or by an application, or over-the-top, OTT, or
wherein the UE is pre-configured with the certain area, e.g., hardwired in case of UEs assumed not to leave the certain area, like UEs in a factory.

In accordance with embodiments (see for example claim 16), the certain area is a defined geographical area or is an area around a certain moving point, like a moving UE, within which the first part of the information element changes as the UE moves but is one of the set of fixed first parts for all UEs within the certain area.

In accordance with embodiments (see for example claim 17), the one or more location information elements describe a global location or a global position of the UE.

In accordance with embodiments (see for example claim 18),
the location information element incudes M bits,
for locations or positions within the certain area, the first part of the location information element includes the n most significant bits of the location information element, and the second part of the location information element includes the M−n+i least significant bits, with i=0, 1, . . . , n−1, n.

In accordance with embodiments (see for example claim 19), the position information includes a number of p bits representing partially the second part of the location information.

In accordance with embodiments (see for example claim 20), the position information includes the most significant p bits out of the second part of the location information element, with 1<=p<=k, and k=M−n+i, with i=0, 1, . . . , n−1, n.

In accordance with embodiments (see for example claim 21), p depends on one or more criteria, e.g., a required precision for indicating the location and/or available bits, e.g., in the SCI.

In accordance with embodiments (see for example claim 22), one or more of M, n, k and p may be selected dependent on an application or a use case.

In accordance with embodiments (see for example claim 23), the one or more criteria for p are pre-configured or configured for different use cases or applications.

In accordance with embodiments (see for example claim 24), the parameter k is selected based on one or more criteria, e.g., a range required to be supported and/or available bits, e.g. in the SCI.

In accordance with embodiments (see for example claim 25), the location or position is described as ellipsoid point coordinates, and the one or more location information elements indicate one or more of a latitude, a longitude, an altitude with or without an uncertainty range.

In accordance with embodiments (see for example claim 26), the certain area includes a predefined zone, e.g., a certain zone of a coverage area of a cell, or a certain zone of a part of or all of the coverage of the wireless communication system, or a certain zone within a geographical area covering part or all of the global area.

In accordance with embodiments (see for example claim 27),
the zone is associated with a zone ID,
the first part of the location information element includes the zone ID, and
the second part of the location information element includes the position of the further UE within the zone.

In accordance with embodiments (see for example claim 28), the second part of the location information element defines an offset of the further UE from a reference point or location in the zone, e.g., from an origin in each zone commonly known in the system.

The present invention provides (see for example claim 29) a user device, UE, for a wireless communication system, the wireless communication system including a plurality of user devices, UEs,
wherein the UE is to communicate with one or more further UEs using a sidelink, SL,
wherein, when being in the certain zone, the UE is to
   receive from a further UE located in the same zone or in a different zone, e.g., using sidelink control information, SCI, a zone ID and location information of the further UE, the location information indicating the position of the further UE within the zone in which the further UE is located, and
   obtain the location or position of the further UE using the location of the UE and the received zone ID and location information of the further UE.

The present invention provides (see for example claim 30) a user device, UE, for a wireless communication system, the wireless communication system including a plurality of user devices, UEs,
wherein the UE is to communicate with one or more further UEs using a sidelink, SL,
wherein, when being in the certain zone, the UE is to transmit to a further UE located in the same zone or in a different zone, e.g., using sidelink control information, SCI, a zone ID and location information of the UE, the location information indicating the position of the UE within the certain zone.

In accordance with embodiments (see for example claim 31), the certain zone includes
a certain zone of a coverage area of a cell, or
a certain zone of a part of or all of the coverage of the wireless communication system, or
a certain zone within a geographical area covering part or all of the global area.

In accordance with embodiments (see for example claim 32), the location information defines an offset of the UE from a reference point or location in the zone, e.g., from an origin in the zone commonly known in the system.

In accordance with embodiments (see for example claim 33), UE knows the reference points or locations of the respective zones.

The present invention provides (see for example claim 34) a user device, UE, for a wireless communication system, the wireless communication system including a plurality of user devices, UEs,
wherein the UE is to communicate with one or more further UEs using a sidelink,
wherein one or more location information elements describe a location or position of a UE, and
wherein, when being in a certain area, the UE is to
   receive at a certain time, e.g., when setting up the SL communication, from the further UE the one or more location information elements including the location information of the further UE, and
   receive at one or more times following the certain time from the further UE further location information indicating a difference between a current location of the further UE and the location signaled at the certain time.

The present invention provides (see for example claim 35) a user device, UE, for a wireless communication system, the wireless communication system including a plurality of user devices, UEs,
wherein the UE is to communicate with one or more further UEs using a sidelink,
wherein one or more location information elements describe a location or position of a UE, and
wherein, when being in a certain area, the UE is to
   transmit at a certain time, e.g., when setting up the SL communication, to the further UE the one or more location information elements including the location information of the UE, and
   transmit at one or more times following the certain time to the further UE further location information indicating a difference between a current location of the UE and the location signaled at the certain time.

In accordance with embodiments (see for example claim 36), the UE is a receiving UE or a transmitting UE in the SL communication.

In accordance with embodiments (see for example claim 37), the one or more location information elements are provided over RRC or over-the-top, OTT, or another type of semi-static signaling, and/or the further location information are provided in or as part of the side link control information, SCI.

In accordance with embodiments (see for example claim 38), the one or more location information elements are provided using a unicast RRC message, a multicast RRC message or a group RRC message.

In accordance with embodiments (see for example claim 39), the UE and one or more of the further UEs form a group, and wherein the UE is to
transmit to the group UEs the one or more location information elements using respective unicast RRC messages or a group RRC message, and
transmit to the group UEs the further location information using a SCI multicast message including, e.g., only the location changes, like a position delta.

In accordance with embodiments (see for example claim 40), in case the one or more location information elements are transmitted to the group UEs using respective unicast RRC messages, the further location information is selected so as to minimize a certain error metric, e.g., a minimum mean square error, MMSE.

In accordance with embodiments (see for example claim 41), the one or more location information elements further include one or more of:
a current height or altitude of the UE, e.g. for flying UEs such as UAVs, drones, helicopters, planes, and
a motion vector or direction of motion of the UE, e.g., to refine the positioning information.

In accordance with embodiments (see for example claim 42), the UE comprise one or more of a mobile terminal, or stationary terminal, or cellular IoT-UE, or vehicular UE, or vehicular group leader (GL) UE, or an IoT or narrowband IoT, NB-IoT, device, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### System

The present invention provides (see for example claim 43) a wireless communication system, comprising a plurality of the inventive user devices, UEs, configured for a sidelink communication using, for example resources from a set of sidelink resources of the wireless communication system.

In accordance with embodiments (see for example claim 44), the wireless communication comprises one or more base stations, wherein the base station comprises one or more of a macro cell base station, or a small cell base station, or a central unit of a base station, or a distributed unit of a base station, or a road side unit (RSU), or a UE, or a group leader (GL), or a relay, or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides (see for example claim 45) a method for obtaining a location or position of a user device, UE in a wireless communication, the wireless communication system including a plurality of user devices, UEs, the method comprising:
performing a communicating among a UE and one or more further UEs using a sidelink, SL, wherein one or more location information elements describe a location or position of a UE, wherein the location information element includes a first part and a second part, wherein, for locations or positions within a certain area, the first part of the location information element is one of a set of fixed first parts and the second part of the location information element varies dependent on the actual or exact location or position of the UE,
receiving from the further UE, e.g., using sidelink control information, SCI, position information of the further UE, the position information including some or all of the second part of the location information element of the further UE, and
obtaining the location or position of the further UE by combining the one of the set of fixed first parts with the position information which is received from the further UE, wherein, in case the set of fixed first parts includes more than one fixed first part, the UE is to select the one of the set of fixed first parts using the position information which is received from the further UE.

The present invention provides (see for example claim 46) a method for providing a location or position of a user device, UE in a wireless communication, the wireless communication system including a plurality of user devices, UEs, the method comprising:
performing a communicating among a UE and one or more further UEs using a sidelink, SL, wherein one or more location information elements describe a location or position of a UE, wherein the location information element includes a first part and a second part,
wherein, for locations or positions within a certain area, the first part of the location information element is one of a set of fixed first parts and the second part of the location information element varies dependent on the actual or exact location or position of the UE, and
transmitting from the UE to a further UE, e.g., using sidelink control information, SCI, position information of the UE, the position information including some or all of the second part of the location information element of the UE.

The present invention provides (see for example claim 47) a method for obtaining a location or position of a user device, UE in a wireless communication, the wireless communication system including a plurality of user devices, UEs, the method comprising:
performing a communicating among a UE and one or more further UEs using a sidelink, SL,
receiving from a further UE located in the same zone or in a different zone, e.g., using sidelink control information, SCI, a zone ID and location information of the further UE, the location information indicating the position of the further UE within the zone in which the further UE is located, and
obtaining the location or position of the further UE using the location of the UE and the received zone ID and location information of the further UE.

The present invention provides (see for example claim 48) a method for providing a location or position of a user device, UE in a wireless communication, the wireless communication system including a plurality of user devices, UEs, the method comprising:
performing a communicating among a UE and one or more further UEs using a sidelink, SL,
when being in a certain zone, transmitting from the UE to a further UE located in the same zone or in a different zone, e.g., using sidelink control information, SCI, a zone ID and location information of the UE, the location information indicating the position of the UE within the certain zone.

The present invention provides (see for example claim 49) a method for providing a location or position of a user device, UE in a wireless communication, the wireless communication system including a plurality of user devices, UEs, the method comprising:
performing a communicating among a UE and one or more further UEs using a sidelink, SL, wherein one or more location information elements describe a location or position of a UE,
receiving at a certain time, e.g., when setting up the SL communication, from the further UE the one or more location information elements including the location information of the further UE, and
receiving at one or more times following the certain time from the further UE further location information indicating a difference between a current location of the further UE and the location signaled at the certain time.

The present invention provides (see for example claim 50) a method for providing a location or position of a user device, UE in a wireless communication, the wireless communication system including a plurality of user devices, UEs, the method comprising:
performing a communicating among a UE and one or more further UEs using a sidelink, SL, wherein one or more location information elements describe a location or position of a UE, and
transmitting at a certain time, e.g., when setting up the SL communication, to the further UE the one or more location information elements including the location information of the UE, and
transmitting at one or more times following the certain time to the further UE further location information indicating a difference between a current location of the UE and the location signaled at the certain time.

### Computer Program Product

Embodiments of the present invention provide a computer program product comprising instructions which, when the program is executed by a computer, causes the computer to carry out one or more methods in accordance with the present invention.

Thus, embodiments of the present invention address the above problems as they are found in conventional technology approaches. The present invention provides various aspects for addressing the above problems, and in accordance with a first aspect an efficient approach is provided so that a location of a user device may be described by fewer bits in such a way that the receiving UE, connected to the transmitting UE via the sidelink, may still extract and/or understand the location/position of the transmitting UE with a desired accuracy. In accordance with embodiments of the first aspect, this allows the receiving UE to calculate a distance to the transmitting UE accurately. In accordance with a second aspect of the present invention, precise location information is sent at a certain point of the transmission, for example when establishing the connection, and following that initial transmission of the precise location, the signaling overhead is reduced by sending at later points, for example when the location of the transmitting UE changed, only the information on the difference between the initial location and the current location, thereby reducing the signaling overhead.

### Aspect 1

In accordance with embodiments of the first aspect of the present invention, a user device, communicating with one or more other user devices over the sidelink, may provide compressed or reduced location information avoiding the signaling overhead on the SCI. The UEs communicating over the sidelink may be located within a certain area so that, when considering a location information element, a first part thereof may be the same for all UEs within the certain area, i.e., the first part of the location information may be one of a set of fixed first parts, while a second part of the location information may vary dependent on the actual position of the respective UE. Therefore, for UEs being located within a certain area, rather than transmitting the entire location information, in accordance with embodiments of the first aspect, only the second part of the location information, namely the part that varies dependent on the actual position of a UE, may be transmitted, thereby reducing the amount of information to be transmitted and thereby the signaling overhead.

At the receiving UE, for example, the actual location or position of the other UE may be determined by combining the one of the set of fixed first parts with the position information which is received from the further UE and includes the second part of the location information element fully or partially.

The set of fixed first parts is known at the UEs in the area. It is noted that fixed does not prevent a change of the set, e.g., an dynamic update of the set. In accordance with embodiments, the set of fixed first parts may be updated dynamically, e.g. in case of a moving UEs, like in a platoon, as is described in more detail below.

In accordance with embodiments, the set of fixed first parts may include only one or a single fixed first part, i.e., for the locations in the certain area the first parts in the location information are common. Then, in the location information associated with the receiving UE the second part thereof may be replaced by the second part received from the transmitting UE, thereby obtaining the actual location or position of the other UE. For example, the information element may include a plurality of bits of which a first part, for example n bits, is common or remains fixed for the UEs being located within the certain area, while a second part of the bits, for example k bits, change or are variable dependent on the actual position of the UE.

In accordance with other embodiments, the set of fixed first parts may include more than one fixed first part, e.g., two fixed parts, and for the locations in the certain area the first parts in the location information may be slightly different. An example for this is a change in longitude or latitude which might occur for close-by positions: although two positions are close-by, one of the positions might already “belong” to the next larger or smaller longitude or latitude, depending on its absolute position on the earth coordinate system. Then, the UE may to select the one of the set of fixed first parts using the position information which is received from the further UE, and combine the selected one of the fixed first parts with the second part received from the transmitting UE, thereby obtaining the actual location or position of the other UE. For example, when considering a binary representation of the location, the fixed first part to be used may be selected dependent on the second part in such a way that, when the received second part includes only 1s and the second part of the receiving UE includes only 0s or vice versa, this indicates that the first part of the TX UE is to be used. On the other hand, in case the received second part increments or decrements in a part of the bit positions when compared to the second part of the receiving UE this indicates that the first part of the RX UE is to be used. Thus, the UE can select the one of the set of fixed first parts depending on pre-configured/network-configured criteria, such as selecting the one of the set of fixed first parts which has the minimum distance to the said UE.

For example, when considering an area in which the position is represented by four bits, the locations of some UEs may be represented by the following binary representation:

| | | | | | | |
|---|---|---|---|---|---|---|
| 0001 | 0010 | 0011 | 0100 | 0101 | 0110 | 0111 |
| 1000 | 1001 | 1010 | 1011 | 1100 | 1101 | 1110 |

In this example, the most significant bit may be considered the fixed first part and the set of fixed first parts includes as one fixed first part “0” and as another fixed first part “1”. The second parts are the three least significant bits. When considering a RX UE having the location 0111 and a TX UE having the location 1000, the RX UE receives from the TX UE as the second part, e.g., “000”. The RX UE notes the change when compared to its second part being “111” and recognizes that the other fixed first part “1” is to be employed for obtaining the location of the TX UE. On the other hand, when considering a TX UE having the location “0011” part increments or decrements in a part of the bit positions, the RX UE notes the change (increment or decrement by 1) in only some of the bits, when compared to its second part being “111”, and recognizes that the one fixed first part “0” is to be employed for obtaining the location of the TX UE.

In accordance with other embodiments of the first aspect, the first part of the information element may include a zone identification indicating a certain zone within which the transmitting UE is actually located, and a second part, which is transmitted, indicates an offset of the UE within the zone, for example with reference to a reference location in the zone, for example a commonly known origin of the zone.

Thus, in accordance with embodiments of the first aspect, the signaling overhead is reduced because for the UEs within the certain area the first part of the information about the location is from a known set of fixed first parts and needs not to be transmitted, rather, it is sufficient to transmit only the second part, fully or partially. In accordance with embodiments, the UE is configured with the certain area, e.g., by
a signaling during a group setup, and/or
a signaling from a network entity, like a RSU or a BS, and/or
an application, and/or
a higher layer entity or element, e.g., a higher layer entity or element associated with the UE, in other words, the configuration may not be exactly from an application, but may be some layer 2 or layer 3 configuration, and/or
over-the-top, OTT.

In accordance with other embodiments, the UE is pre-configured with the certain area, e.g., hardwired in case of UEs assumed not to leave the certain area, like UEs in a factory.

In accordance with embodiments, the certain area may be a defined geographical area, like a junction or an area of a factory or the like, while, in accordance with other embodiments, the certain area may be an area around a certain moving point, like a moving UE, and within this area the first part of the information element may change as the UE moves but is one of the set of fixed first parts for all UEs within this certain area. In such a scenario, as the U moves, some fixed first parts may longer by valid but new fixed first parts may become valid, e.g., in case the moving UEs travel over for a substantial distance. In other words, in such a scenario, a dynamic update of the set off fixed first parts takes place. The set of fixed first parts may be updated dynamically by replacing one or more fixed first parts being no longer valid by valid ones.

Only some or all of the varying part of the information, the above mentioned second part, needs to be transmitted, thereby reducing the signaling overhead while, at the same time, allowing the receiving UE to estimate or determine the actual location of the transmitting UE with a desired accuracy by combining one of the set of fixed first parts of the location information already available at the receiving UE with the received second part of the information.

When considering the above described location information elements, IE, describing, for example, the latitude, the longitude and/or the altitude, each IE is expressed in a number of bits. In general, the number of bits required for different IEs of the location may be different, for example dependent on the positioning system and/or the coordinates that are used. In accordance with embodiments of the first aspect of the present invention employing the above described information elements describing the location by its latitude, longitude, altitude and the like, the above mentioned certain area within which a plurality of UEs communicating over the sidelink are provided, for example a group of UEs, like a V2X group, may be defined when setting up the group for the sidelink communication, or it may be provided by the system, e.g., an application or by a RSU, as a default setting. In the following, embodiments of the first aspect are described with reference to the transmission of one information element, IE, describing a global position of a UE, and the IE may include both latitude and longitude information. In accordance with other embodiments, different IEs for the respective coordinates may be transmitted. Also, the inventive approach is not limited to the signaling of a global position of a UE, rather, it may also be applied to the signaling of a relative position of the UE within a certain predefined geographical area, like the entire coverage of a wireless communication system or any other arbitrarily selected geographical area.

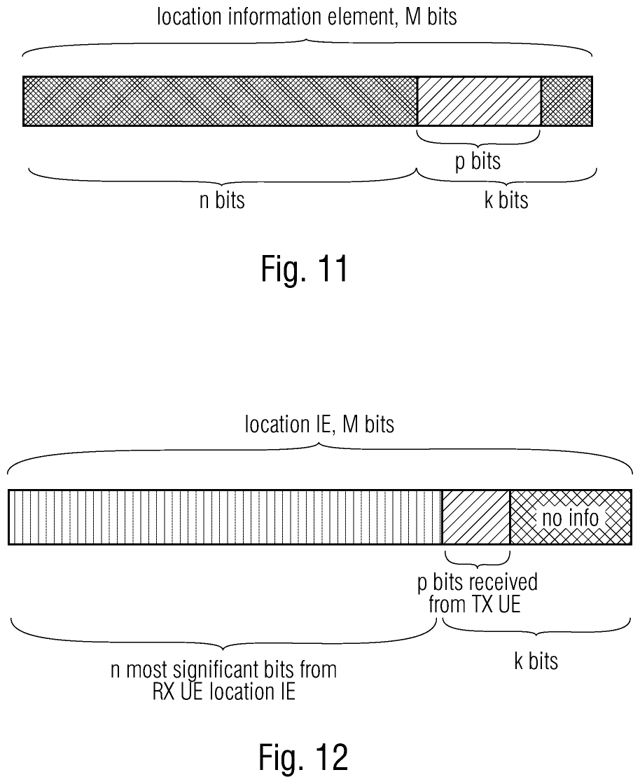

FIG. 11 illustrates schematically a location information element including M bits. For example, when considering the IE of FIG. 11, to define the global position of a transmitting UE, for locations or points that are within the predefined area the n most significant bits of the IE are the same or are common or deducible, and only the M-n least significant bits vary and/or are not deducible. The predefined area may also be referred to as a limited area which may be a default area or may be set when establishing the communication. The representation of the IE may be binary, and it may change circularly. FIG. 11 illustrates k bits where k is defined as follows: k=M-n+i, where “i” varies between 0 and n. This allows to include into the second part also bits from the first part. In other words, the second part may overlap on “i” bits with the first part. By considering a larger value for “i” a larger minimum communication range and/or area can be considered or maintained, i.e., when the distance between UEs increases to more than an originally planned distance until some larger distance limit, the receiving UE is still able to calculate the location of the transmitting UE. The so-called larger distance limit depends on the value of “i”.

For reducing the signaling overhead for signaling the position of the transmitting UE to a receiving UE located within the predefined area, for example the predefined area around the transmitting UE, the k least significant bits of the IE may be employed, and only some or all of the k least significant bits may be signaled using the SCI, thereby significantly reducing the number of bits to be signaled in the SCI. For example, in accordance with embodiments, based on a desired precision/accuracy and/or based on the availability of bits, for example in the SCI, only p significant bits out of the k-bit part may be selected, for example 1≤p≤k. The p-bit part is the part of the IE that is transmitted to the one or more receiving UEs. In case the IE illustrated in FIG. 11 only includes one coordinate, the same process may be employed to the other coordinates of the location in other location IEs.

In accordance with embodiments, the required precision and/or the required area parameter of the group, p, may be as low as 3 to 4 bits. For example, when considering a distance between two points on earth, calculated according to their positions, in typical V2X applications the area parameter of a group R is between 50 meters Rₘᵢₙ to 500 meters Rₘₐₓ.

Rₘᵢₙ≤R≤Rₘₐₓ (6)

When assuming that a latitude for two points is the same, and only the longitude is different between the two locations, a 50 meters (Rₘᵢₙ) difference is equivalent to a difference of almost 0.000472 degrees in longitude, which, in accordance with equation 1 above, yields the following:

2²³/90×0.000472=43.99→N=43→6 bits

Thus, when considering an area of 50 meters as the predefined or certain area within which the UEs are located, for example an area of 50 meters around the transmitting UE or around a certain location, the 6 least significant bits, out of the 23 bits, of the longitude IE varies and the rest of the bits are common among the UEs in the area or fixed.

When assuming that a latitude for two points is the same, and only the longitude is different between the two locations, a 500 meter (Rₘₐₓ) difference in the distance is equivalent to a difference of almost 0.004722 degrees in latitude, yielding, in accordance with equation 1 above, the following:

2²³/90×0.000472=439.93→N=439→9 bits

Thus, when considering an area of 500 meters within which the UEs are located, for example an area of 500 meters around the transmitting UE or around a certain location, the 9 least significant bits out of the 23 bits of the longitude IE vary and the rest of the bits are common among the UEs in the area or fixed.

For example, when considering a group of UEs, in which a receiving UE is to be within 500 meters of the transmitting UE or within 500 meters around a certain spot or location, in case the transmitting UE sends the 3 or 4 most significant bits out of the 9 least significant bits of the longitude IE, the receiving UE is able to construct the location of the TX UE in a way as shown in FIG. 12. FIG. 12 illustrates an embodiment in accordance with which the location of a transmitting UE is deduced using the location IE of the receiving UE and a received part, for example p bits, of the location IE of the TX UE. More specifically, when receiving from the transmitting UE the above mentioned p bits, the receiving UE deduces the location IE of the transmitting UE, i.e., the location or position of the transmitting UE, by combining the p bits received from the TX UE with the n bits of the first part of the location information element of the receiving UE. Thus, as is illustrated in FIG. 12, the location IE for the transmitting UE as deduced by the receiving UE includes the n most significant bits from the RX UE location IE and the p bits received from the TX UE.

In accordance with the above described examples for signaling the location information, m may be 23 bits, k may be 9 bits and p may be 3 or 4 bits dependent on the required accuracy. For example, dependent on the area and/or the required accuracy and/or the available bits in the SCI the parameters, p and k may be defined or adjusted. In FIG. 12, only a part of the k bits is used, i.e., the k-p bits carry no information about the location. For a higher accuracy, the number of p bits is higher and may be as high as k bits, and for a lower accuracy less than the illustrated p bits may be signaled.

Thus, in accordance with embodiments of the first aspect, UEs communicating over a sidelink, for example UEs of a certain group, like a V2X group, or UEs communication with other sidelink capable network entities, like an RSU, may be configured or preconfigured with the certain area. The information may be a location information element describing the certain area around a certain UE in the group, like a leader UE, or an area within which the UEs are located. For the area, the location information element may be common or fixed, and a UE may obtain the location of the transmitting UE by combining the configured or preconfigured location IE with the received part of the position information from the transmitting UE as described above with reference to FIG. 12. In other embodiments, in case a certain area is defined and known to all UEs of the group, e.g., the area within which the UEs are to be located, like a factory, the area may be preconfigured, e.g., hardwired in the UE. For obtaining the location or position of the transmitting UE, the area information, like n bits defining the coordinates of the area, preconfigured in the receiving UE may be combined with the received position information of the further UE.

In accordance with embodiments, the parameters k and/or p may be adapted based on an application or use case. For example, different use cases may have different requirements on the parameters such as the area or accuracy. For example, a grouping around a traffic junction may not need to support a larger area than the size of the junction itself, however, accuracy is more important to avoid crashes. Another example for a use case is a platooning use case where a larger area needs to be supported so as to cover all moving UEs within the area of, for example, the leader UE. In such a scenario providing the larger area is more important and the accuracy requirements may not be as stringent as in the junction scenario. Hence, the application may decide about the parameters k and p to use dependent on certain limitations associated with a scenario, for example, a maximum number of the common or fixed bits and the variable number of bits for signaling the position in the SCI. This information may be forwarded to the lower layers which then choose which bits to transmit in the SCI at the transmitter side or how to interpret the received bits at the receiver side. The application may implicitly know by the use case it is designed for what the required range and accuracy is and, hence, the parameters p and k may be fixed for that application. On both ends of the communication link, the application layer may inform the lower layers about the parameter selection. In another example, the applications running on both ends of the communication link may negotiate the parameters and inform the lower layers afterwards. Before the negotiation process is finished the lower layers may assume default values for p and k. In another example, the application on one end of the communication may decide and indicate all or some of the parameters and informs its lower layers. The other end of communication then is configured with the parameters, e.g., by signaling from the former end of communication.

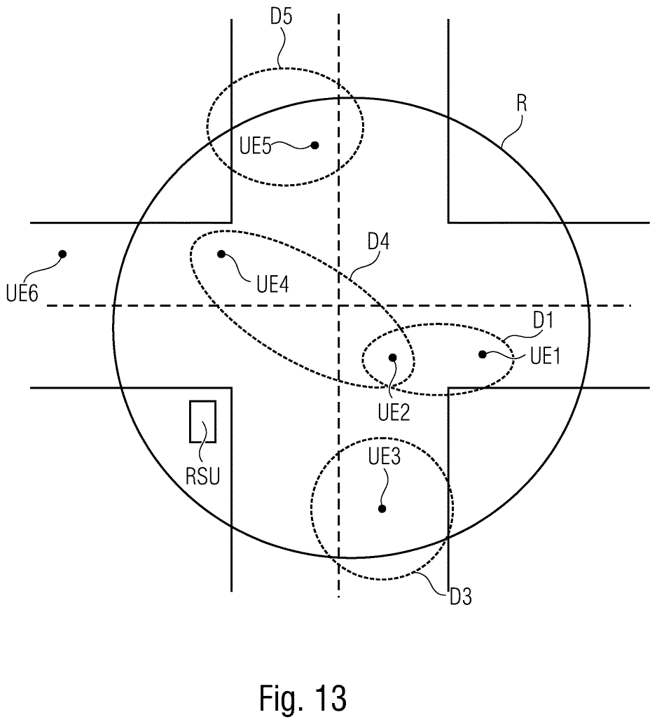

FIG. 13 shows an embodiment of the first aspect of the present invention employed at a street junction at which two roads intersect. The certain area R is indicated in FIG. 13 and, as mentioned above, basically covers the size of the junction. Location information elements defining a position or location within the area R have the same or common most significant bits, and dependent on the actual location within the area R, the k bits differ. For example, when approaching the junction, respective UEs may be informed accordingly, e.g., by a RSU shown in FIG. 13 adding the UEs approaching or entering the area to a group and including, e.g., in the group information, an indication of the area. For example, the number n of common bits in the location information elements may be included enabling the UEs to combine the n most significant bits form their location information elements with the received p bits from a transmitting UE. Thus, when entering the area R a position of a transmitting UE may be determined in a way as described above. In the example depicted in FIG. 13, UE1 to UE5 are within the area R and UE2 is assumed to be a transmitting UE so that UE1 and UE3 to UE5 may determine a location of UE2 using the partial information received from UE2 via the sidelink channel, for example via the SCI, which, for example, allows the respective UEs to recognize that UE2 is in the intersection thereby alerting them that entering the junction at a certain period of time is not possible or that evasive actions may be taken, for example breaking or stopping of UE1 and UE4. UE5 and UE3 may recognize that no evasive action is needed as there is no likelihood of collision.

Thus, in the embodiment of FIG. 13, the respective UE1 to UE5 determine a location of a transmitting UE within area R. On the other hand, UE6 is not within the area R so that it may not be enabled to determine the location of a TX UE as described herein, even when receiving the second part of the location information element form the TX UE. In accordance with embodiments, on the basis of the deduced location IE of the TX UE, the receiving UE may determine its distance to the transmitting UE so as to find out whether it is within a certain communication range or not. In FIG. 13, UE1 and UE3 to UE5 may determine whether UE2 is within a predetermined distance D1, D3 to D5. Dependent on the distance, the respective UEs may decide whether certain operations are to be performed or not. For example, when considering all UEs within the area R to be members of a group, a TX-RX distance-based HARQ feedback for the groupcast may be implemented. For example, as described in Reference [4], a range for group communication may employed for sidelink physical layer procedures. In case of a TX-RX distance-based HARQ feedback for groupcast, a UE transmits HARQ feedback for the PSSCH if the TX-RX distance is smaller or equal to a communication range requirement. Otherwise, the UE does not transmit HARQ feedback for the PSSCH. The TX UE's location is indicated by SCI associated with the PSSCH, as described herein. The TX-RX distance is estimated by the RX UE based on its own location and TX UE location. The used communication range requirement for a PSSCH is known after decoding a SCI associated with the PSSCH.

Thus, a UE may transmit a HARQ feedback for the PSSCH in case the TX-RX distance is smaller or equal to a communication range requirement, otherwise, the UE does not transmit a HARQ feedback for the PSSCH. As mentioned above, the TX UE's location, namely the location of UE2 in the example of FIG. 13, is indicated by the SCI associated with the PSSCH, more specifically, some or all of the second part of the information element of UE2 is transmitted. Based on this information, in a way as described above, UE1 and UE3 to UE5 determine a location of UE2 and, based on their own location UE1 and UE3 to UE5, the TX-RX distance D1, D3 to D5 is obtained or calculated so as to determine whether a HARQ feedback, responsive to a transmission on the PSSCH is to be sent to the UE2. In the depicted embodiment of FIG. 11, UE2 is within the distances D1 and D4 of UE1 and UE4, respectively, so that responsive to a transmission from UE2, UE1 and/or UE4 provide a feedback to UE2. On the other hand, UE2 is outside the distances D3 and D5 of UE3 and UE5, respectively, so that, when receiving a transmission from UE2, they do not provide a HARQ feedback. For example, a HARQ feedback is not needed for groupcast transmissions, because of the enlarged distance D in situations where the required quality of service requirements cannot be met at the said distance. In such a scenario, UEs being far off may request frequently retransmissions from the transmitter UE due to the high path loss which is caused by the large distance although the quality of service cannot be provided anyway at such a large distance. This would degrade the efficiency of the transmission.

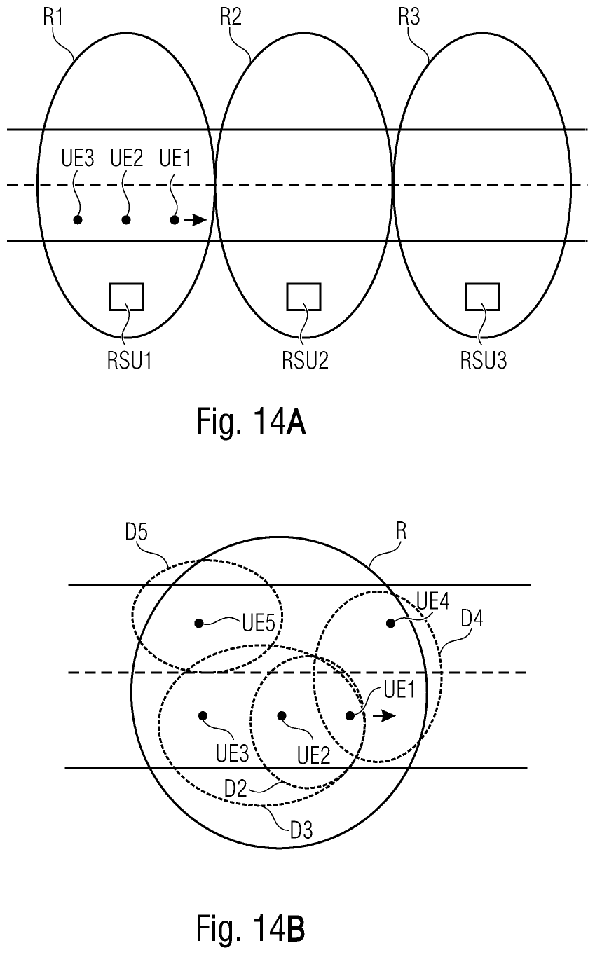

FIGS. 14A-14B illustrate a further embodiment in the case of a platooning application. FIG. 14A illustrates the platoon including UE1 to UE3 moving along a road. Along the road respective RSUs are located, RSU1, RSU2, RSU3. Each RSU covers a certain area R1, R2, R3 around it, and each area R1, R2, R3 may span or cover a certain geographical region. In the depicted embodiment, the platoon in area R1 and the UEs of the platoon are aware of the area R1, and the first part of the information element of the respective UEs being within the area R1 is the same and the second part varies dependent on the location within the area R1. Thus, when considering a transmitting UE, e.g., a platoon leader UE1, all UEs within area R1, namely the platoon members and also UE6 and UE7 not being part of the platoon, may determine a location of the UE1 in accordance with the above described approaches. As the platoon moves along the road it eventually leaves area R1 and enters area R2. The UEs may receive information, e.g., from RSU2, about the area R2, for example, information about the common part of their information elements, so that, as the platoon moves along the road, receiving UEs may determine a location of a transmitting UE as described above. In accordance with other embodiments, the information about the respective areas may be signaled during the group setup, e.g., based on the knowledge of the route all area information may be provided to the UEs, or may be provided by an application or over-the-top, OTT.

In accordance with other embodiments, rather than having information about the respective areas R1, R2, R3, as in FIG. 14A, the UEs of the platoon may consider an area around one of the UEs in the group, like the platoon leader UE1, as is illustrated in FIG. 14B. More specifically, the area R around the platoon leader UE1 may be known by all UEs, UE1 to UE3. Thus, the first parts of the location elements of the UEs being within this area R are common to all UEs in the platoon. For example, for a certain area all UEs in the platoon know that n bits in the location element are common, although these bits change when the platoon is moving. In other words, the certain area may be an area around a certain moving point, like a moving UE, and within this area the first part of the information element may change as the UE moves but remains common or is assumed to remain common to all UEs within this certain area. It is noted that this applies not only to UE groups but to also to UEs not being member of a group.

As is further illustrated in FIG. 14B, around the receiving UEs, e.g., UE2 to UE5, a communication distance D2 to D5 may be defined, and in case a receiving UE determines UE1 to be within the communication range, in a way as described above, the UE may provide respective operations, like the above-described HARQ feedback. For example, all members of the platoon, when receiving from UE1 a transmission, provides a feedback because UE1 is within the communication ranges D2 to D3. In addition, a UE4 traveling in the opposite direction and for which UE1 is within the range D4 may provide a feedback to the UE1. On the other hand, UE5 which already passed the platoon and may see that UE1 is outside range D5, and, while still being in a position to determine the location in a way as described above, does not provide a feedback to UE1.

It is noted that the inventive approach is not limited to the scenarios described above with reference to FIG. 13 and FIGS. 14A-14B, rather, it may be employed in any scenario in which UEs communicate over the SL and need to determine a position or location of a transmitting UE, e.g., a scenarios in which UEs, like robots, are located or move within a factory.

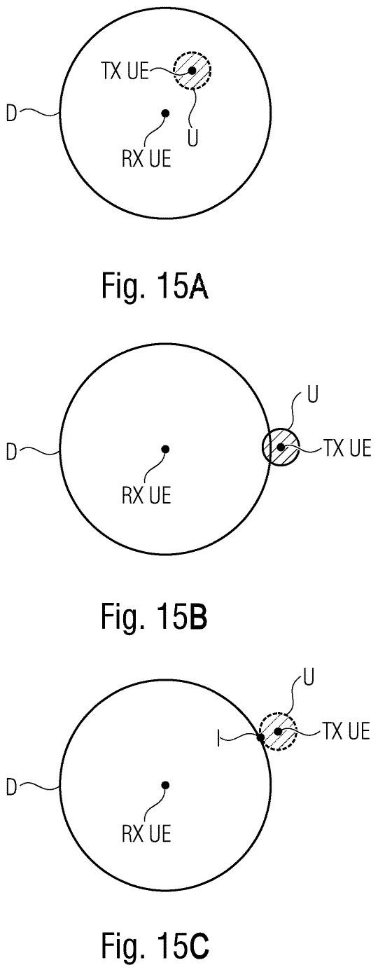

As described above, with reference to FIG. 13 and FIGS. 14A-14B, in accordance with embodiments of the first aspect a minimum required communication range D may be determined around a receiving UE. Embodiments provide an approach to cope with a reduced accuracy, which may be experienced because of the number of p bits is substantially smaller than the number of k bits. Embodiments allow to cope with the reduced accuracy to determine a minimum required communication range D, for example, to decide whether the HARQ feedback is to be transmitted or not. Based on the accuracy requirement, for example k-p, a UE may estimate an area of uncertainty for the location or position of the transmitting UE. Moreover, the UE may define the area of its minimum required communication range D, for example by a circle around the UE's position having as the diameter the minimum required communication range D. FIGS. 15A-15C illustrate an embodiment for determining whether a minimum required communication range is met for a communication between a transmitting UE and a receiving UE. In FIG. 15A the transmitting UE, TX UE, and the receiving UE, RX UE, are illustrated. It is assumed that the RX UE obtained from the TX UE the location information in a way as described above and, dependent on the accuracy requirement, determines the uncertainty range U around the TX UE, i.e., an area around the TX UE within which the TX UE may be actually located given the accuracy of the received second part of the information element.

FIG. 15A further illustrates the minimum required communication range D around the RX UE, and the RX UE determines that the TX UE is within the minimum required communication range because the whole area of uncertainty U is within the area of the minimum required communication range D. FIG. 15B illustrates another embodiment, in accordance with which the TX UE is considered to be within the minimum required communication range because the part of the area of uncertainty U overlapping with the area defined by the distance D exceeds a certain threshold. For example, at least ⅓ of the area U is within the area D, i.e., a threshold may be provided defining that a certain percentage of the area of uncertainty is to be within the area D so as to determine the TX UE to be within the minimum required communication range. Instead of a percentage, also an absolute value of the area may be defined. The threshold may be configured or preconfigured within the RX UE. FIG. 15C illustrates yet another embodiment in accordance with which the TX UE is determined to be within the minimum required communication range in case the area defined by the minimum required communication range D and the area of uncertainty U meet at least at one point I. Otherwise, the TX UE is determined to be outside the minimum required communication range D.

In accordance with other embodiments, the minimum required communication range D may be determined around a receiving UE without using the area of uncertainty. In such embodiments, the location of the TX UE as obtained by the receiving is used and it is determined whether this location is within the minimum required communication range D. For example, when considering FIGS. 15A-15C, in FIG. 15A the TX UE is considered to be within the minimum required communication range D, while in FIG. 15B and in FIG. 15 C the TX UE is considered to be outside the minimum required communication range D.

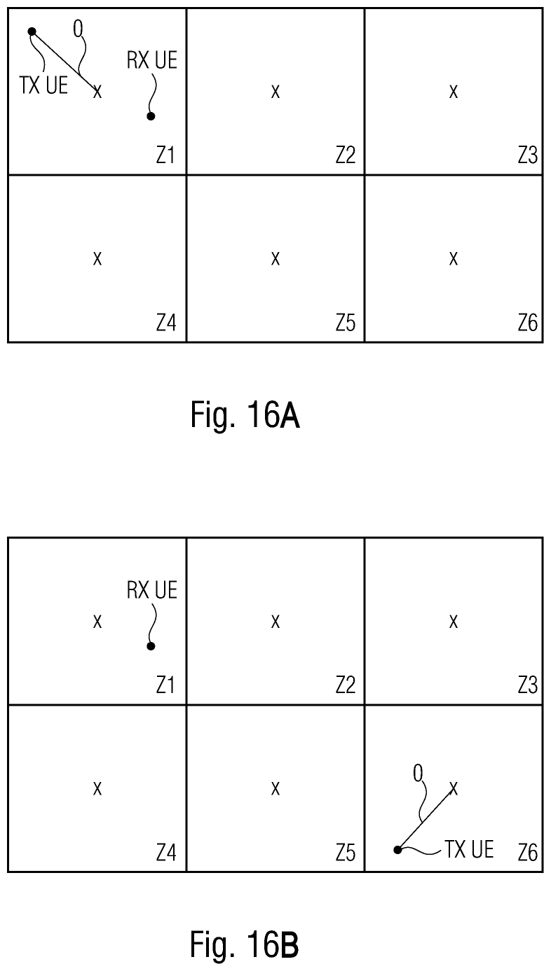

In accordance with other embodiments of the first aspect of the present invention, rather than using coordinates, like the ellipsoid coordinates described above, also the above-mentioned zone concept may be employed. FIGS. 16A-16B illustrates embodiments of the present invention employing a zone concept for obtaining the location of a transmitting UE. FIG. 16A illustrates schematically an area or coverage A. The area or coverage A may by a coverage area one or more of a plurality of bases stations of a wireless communication network or system, may be a part or all of an area covered by a wireless communication network or system, or may be a certain geographical area on the earth, e.g., independent of a wireless communication network or system, or may be the entire surface of the earth. The area A is divided into a plurality of zones, and FIG. 16A illustrates some of the zone z1 to z6. Naturally, more or less zones may exist. Each zone has a zone ID and a reference point or an origin x. For example, when considering the situation depicted in FIG. 13, the area within which the junction is located may be within a zone z1 having associated therewith the zone ID1 and each UE within the zone z1 is aware of the zone ID. FIG. 16A assumes that the TX UE and the RX UE are within the same zone, namely zone z1. For example, when entering a certain zone, a UE may receive from a base station, e.g., via the Uu interface, or from a RSU, e.g., via the Uu interface or via the PC5 interface, information about the zone ID. In accordance with other examples the UE may be aware of a map of zones and zone IDs. All UEs have knowledge about the origin in each zone, so that a location information transmitted within the zone only includes, in accordance with further embodiments of the first aspect, an offset or distance O of the TX UE from the zone's origin x. For example, in FIG. 16A, the TX UE only sends, e.g., via the SCI, information about its distance O from origin x to the RX UE within the zone z1 so that the number of information to be transmitted by the UE in the SCI for indicating its location is reduced, as only the offset needs to be signaled.

In accordance with other embodiments of the first aspect using zone IDs the TX UE and the RX UE are located in different zones. FIG. 16B illustrates an embodiment in accordance with which the TX UE is in zone z6 and the RX UE is in zone z1. The RX UE in zone z1 receives from the TX UE located in the zone z6, e.g., using sidelink control information, SCI, the zone ID and location information of the TX UE. The location information indicates the position of the TX UE within the zone z6. The UE obtains the location or position of the TX UE using its location (the location of the RX UE in zone z1) and the received a zone ID and location information of the TX UE. The location information indicates the offset O of the TX UE from the reference point x in zone z6, e.g., from an origin in the zone commonly known in the system. In accordance with other embodiments, the TX UE may signal the zone ID and its offset also in case the TX UE and the RX UE are within the same zone.

In a similar way as in FIG. 16A, also in FIG. 16B the number of information to be transmitted by the UE in the SCI for indicating its location is reduced, as only the zone ID and the offset needs to be signaled, and the amount of information to be signaled is substantially less than signaling the UE coordinates. For example three bits may be allocated to indicate eight possible zones. For the example square shape zone of 500 meters by 500 meters, if 3 bits are allocated to each of the perpendicular X-Y coordinates, the location of the UE can be deduced with the accuracy of +/−32 meters over each of the X and Y coordinates. In this example the total number of required bits are 9 bits, i.e. 3 bits for the zone, in addition to the 3 bits for each of the X and Y coordinates within the zone. Increasing the number of bits to indicate X and Y coordinates increases the accuracy.

For example, in the above described embodiments the zone ID may be signaled via SCI, and the more precise location within the zone, namely the above-mentioned offset, may be signaled via RRC in the PSSCH or vice-versa, i.e., the zone ID may be signaled via RRC and the offset may be signaled via SCI. In either case, the amount of information or number of bits to be transmitted within the SCI is reduced in accordance with this embodiment. When this signaling concept on different layers via SCI on the physical layer (PHY) and via RRC on the medium access layer (MAC) is configured, the UE is knowledgeable about this cross-layer signalling approach and will be (pre-)configured on how to assemble the relevant information elements received via the two or more different control messages. Furthermore, if 2-stage SCI is used, parts of the location information can be in the first part of the SCI, and/or the second part of the SCI, and/or a higher layer signaling, e.g. such as transmitted via RRC signaling. In one example, for TX-RX distance-based HARQ feedback for groupcast, the location information of TX UE can be indicated by the 2^{nd} stage SCI payload.

When determining the location of a TX UE in the above described way using the zone IDs and the offset, in accordance with embodiments, in the same way as described above with reference to FIG. 13, FIGS. 14A-14B or FIGS. 15A-15C on the basis of the deduced location of the TX UE, the receiving UE may determine its distance to the transmitting UE so as to find out whether it is within a certain communication range or not.

It is noted that the embodiments above are described in detail with reference to scenarios in which all location elements of UEs in the certain area include the same first part. However, the present invention is not limited to these embodiments, rather, the above described use of a set of fixed first parts, e.g., the use of two slightly different fixed first parts, may be employed in these embodiments as well.

### Aspect 2

In accordance with embodiments of the second aspect, a hybrid control signaling protocol is provided. The location, for example, a precise location information of a transmitting UE may be sent over the RRC, for example at a certain time, like a time of establishing a communication with one or more receiving UEs over the sidelink. For signaling the location at a later time, rather than transmitting the entire information again, the transmitting UE only transmits the difference or delta between the location that was initially sent, for example, over RRC, and the current location in the SCI. Thus, the amount of information to be transmitted for signaling a location of the transmitting UE is reduced in the SCI.

The RRC transmission of the precise location may be a unicast transmission to each receiving UE or may be a multicast or a groupcast transmission to all receiving UEs within a group, wherein a group may include one or more UEs. The SCI may be sent also a unicast to each receiving UE or as a multicast or groupcast message to all UEs. In case of signaling respective unicast RRC messages for each member of the group independently, each message includes the same location information of the TX UE. During the groupcast communication or during a communication with one RX UE, only location changes are sent on the multicast or unicast SCI, for example a delta or difference in the position at the time of signaling the precise location and the current time.

In case of using multiple unicast RRC messages for signaling to the respective RX UEs, the precise location information, e.g., in case of a moving TX UE and/or in case of moving RX UEs, the consistency of the information among the members of the group may not be guaranteed so that, in accordance with embodiments, the location change, i.e., the position delta, which is transmitted in the SCI may be determined differently since it is different for different UEs having different knowledge on the TX UE position. In accordance with embodiments, this issue may be addressed by choosing a delta value that minimizes a certain error metric, like a minimum means square error, MMSE. In case the differences among the group members are below a certain threshold, the TX UE may ensure that the group members estimate the distance with an accuracy which is within predefined limits. For example, let X1, X2, . . . , Xn be the positions signaled to n different UEs of a group with some slight differences because the UEs keep moving. The delta d to be signaled in the SCI for the groupcast transmission is chosen such that an error metric E(d) is minimized. For example, let Z be the true current position, then the respective errors are given by E1=Z−(X1+d), . . . , En=Z−(Xn+d). An error metric may be used to minimize the average error to choose d such that it minimizes the average error. For example, MMSE is given by E(d)=(Z−(X1+d))²+ . . . +(Z−(Xn+d))². Now d is chosen such that d minimizes E(d), i.e., d=arg min_d E(d).

When determining the location of a TX UE in accordance with the second aspect, in accordance with embodiments, in the same way as described above with reference to FIG. 13, FIGS. 14A-14B or FIGS. 15A-15C on the basis of the deduced location of the TX UE, the receiving UE may determine its distance to the transmitting UE so as to find out whether it is within a certain communication range or not.

### General

In the embodiments described above, reference has been mainly made to a RX UE receiving the location information from the TX UE in accordance with the inventive approach. However, the present invention is not limited to RX UEs, rather, the above described UE may also be TX UEs that provide the location information from the TX UE in accordance with the inventive approach to the RX UEs. For example, the UEs described herein may by a receiving UE or a transmitting UE in the SL communication.

In the above described embodiments, reference has been made to information elements that include X- and Y-coordinates. The location information, in accordance with all embodiments described herein, may also include information on a current height or altitude of the UE, for example, for flying UEs such as UAVs, drones, helicopters, planes. Moreover, the information element, in accordance with other embodiments, may include a motion vector or a direction of motion so as to allow refining the positioning information. The additional information about the altitude or height and/or the additional information about the motion vector or the direction of motion may be combined with any of the embodiments described above, for example, the position delta in accordance with the second aspect may be sent via the SCI and is linked to a height information that may sent via RRC.

Embodiments of the present invention have been described in detail above, and the respective embodiments and aspects may be implemented individually or two or more of the embodiments or aspects may be implemented in combination.

With regard to the above-described embodiments of the various aspects of the present invention, it is noted that they have been described in an environment in which a communication is between a transmitter, like a TX UE, and a receiver, like a RX UE, in a V2X scenario. However, the invention is not limited to such a communication, rather, the above-described principles may equally be applied for any device-to-device communication over the sidelink, like a D2D, V2V communication.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, may be one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity. The base station, BS, may be implemented as mobile or immobile base station and may be one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11 be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

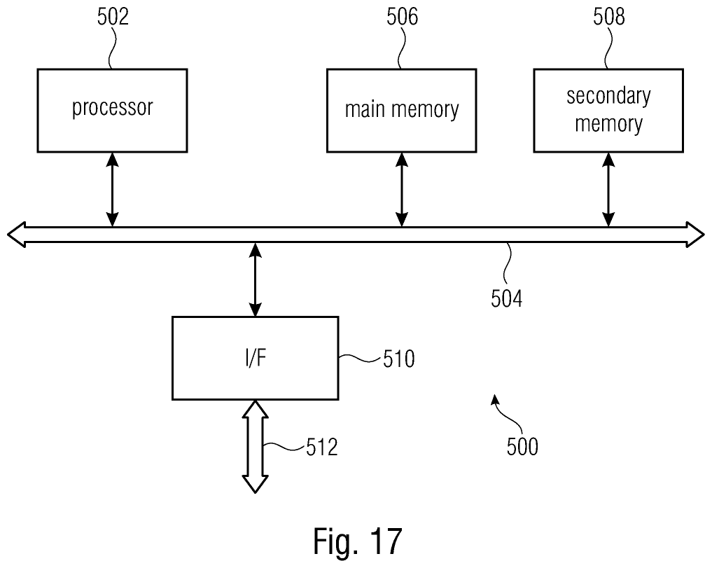

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 17 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The above described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

LIST OF ACRONYMS AND SYMBOLS

| | |
|---|---|
| BS | Base Station |
| CBR | Channel Busy Ratio |
| D2D | Device-to-Device |
| EN | Emergency Notification |
| eNB | Evolved Node B (base station) |
| IE | Information Element |
| FDM | Frequency Division Multiplexing |
| LTE | Long-Term Evolution |
| PC5 | Interface using the Sidelink Channel for D2D communication |
| PPPP | ProSe per packet priority |
| PRB | Physical Resource Block |
| ProSe | Proximity Services |
| RA | Resource Allocation |
| SCI | Sidelink Control Information |
| SL | sidelink |
| sTTI | Short Transmission Time Interval |
| TDM | Time Division Multiplexing |
| TDMA | Time Division Multiple Access |
| TPC | Transmit power control/transmit power command |
| UE | User Entity (User Terminal) |
| URLLC | Ultra-Reliable Low-Latency Communication |
| V2V | Vehicle-to-vehicle |
| V2I | Vehicle-to-infrastructure |
| V2P | Vehicle-to-pedestrian |
| V2N | Vehicle-to-network |
| V2X | Vehicle-to-everything, i.e., V2V, V2I, V2P, V2N |

### REFERENCES

[1] 3GPP TS 36.331 Radio Resource Control (RRC); Protocol specification
[2] 3GPP TS 23.032 Universal Geographical Area Description (GAD)
[3] 3GPP TS 36.355 LTE Positioning Protocol (LPP)
[4] 3GPP RAN1 #97 Chairman notes

1. A user device, UE, for a wireless communication system, the wireless communication system comprising a plurality of user devices, UEs,
wherein the UE is to communicate with one or more further UEs using a sidelink, SL,
wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE, and
wherein, when being in the certain area, the UE is to
receive from the further UE, e.g., using sidelink control information, SCI, position information of the further UE, the position information comprising some or all of the second part of the location information element of the further UE, and
acquire the location or position of the further UE by combining the one of the set of fixed first parts with the position information which is received from the further UE, wherein, in case the set of fixed first parts comprises more than one fixed first part, the UE is to select the one of the set of fixed first parts using the position information which is received from the further UE.

2. The user device of claim 1, wherein, in case the set of fixed first parts comprises only one fixed or common first part, the UE is to acquire the location or position of the further UE by replacing in the UE's location information element the second part by the position information which is received from the further UE.

3. The user device of claim 1, wherein, in case the set of fixed first parts comprises more than one first parts, the UE is to select a first part out of the set of first parts based on an association which maps different subsets of the position information which may be received, to a different first part out of the set of first parts.

4. The user device of claim 3, wherein the user device is configured with the association which explicitly indicates the subsets and their respective associated first part out of the set of first parts, by the network, a further UE or an application, or is preconfigured.

5. The user device of claim 3, wherein the association may be determined by the UE, e.g. the UE combines the position information which is received from the further UE with all different first parts out of the set of first parts and selects the first part which results to a position that is closest to its own position.

6. The user device of claim 1, wherein the set of fixed first parts is to be updated dynamically, e.g. in case of a platoon.

7. The user device of claim 1, wherein the UE is to determine a distance to the further UE using the location of the UE and the location of the further UE.

8. The user device of claim 1, wherein, dependent on a minimum required communication range, the UE is to decide whether a certain operation is to be performed, e.g., whether a HARQ feedback is to be transmitted or not to the further UE.

9. The user device of claim 8, wherein the UE is to
determine an area of minimum required communication range around the UE,
estimate an area of uncertainty around the further UE, dependent on the amount of the second part of the location information element received, and
determine whether the further UE is within the minimum required communication range or not using the area of uncertainty around the further UE and the area of minimum required communication range.

10. The user device of claim 8, wherein the UE is to
determine an area of minimum required communication range around the UE, and
determine whether the further UE is within the minimum required communication range or not.

11. The user device of claim 9, wherein the UE is to determine that the further UE is within the minimum required communication range in case one out of the following criteria is met:
the whole area of uncertainty is within the area of minimum required communication range,
at least a certain portion of the area of uncertainty is within the area of minimum required communication range,
the area of uncertainty and the area of minimum required communication range meet at least in one point.

12. The user device of claim 11, wherein, to determine that the further UE is within the minimum required communication range, in case at least a portion of the area of uncertainty is within the area of minimum required communication range, the UE is to decide whether the portion of the area of uncertainty being within the area of minimum required communication range meets a certain condition, e.g., a pre-configured or configured threshold indicting an absolute size of the portion or a size of the portion relative to the area of uncertainty, like a percentage.

13. A user device, UE, for a wireless communication system, the wireless communication system comprising a plurality of user devices, UEs,
wherein the UE is to communicate with one or more further UEs using a sidelink, SL,
wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE, and
wherein, when being in the certain area, the UE is to transmit to the further UE, e.g., using sidelink control information, SCI, position information of the UE, the position information comprising some or all of the second part of the location information element of the UE.

14. The user device of claim 1, wherein the UE is a receiving UE or a transmitting UE in the SL communication.

15. The user device of claim 1, wherein
the UE is configured with the certain area, e.g., by a signaling during a group setup or a signaling from a network entity, like a RSU, or by an application, or over-the-top, OTT, or
wherein the UE is pre-configured with the certain area, e.g., hardwired in case of UEs assumed not to leave the certain area, like UEs in a factory.

16. The user device of claim 1, wherein the certain area is a defined geographical area or is an area around a certain moving point, like a moving UE, within which the first part of the information element changes as the UE moves but is one of the set of fixed first parts for all UEs within the certain area.

17. The user device of claim 1, wherein the one or more location information elements describe a global location or a global position of the UE.

18. The user device of claim 17, wherein
the location information element incudes M bits,
for locations or positions within the certain area, the first part of the location information element comprises the n most significant bits of the location information element, and the second part of the location information element comprises the M−n+i least significant bits, with i=0, 1, . . . , n−1, n.

19. The user device of claim 17, wherein the position information comprises a number of p bits representing partially the second part of the location information.

20. The user device of claim 19, wherein the position information comprises the most significant p bits out of the second part of the location information element, with 1<=p<=k, and k=M−n+i, with i=0, 1, . . . , n−1, n.

21. The user device of claim 19, wherein p depends on one or more criteria, e.g., a required precision for indicating the location and/or available bits, e.g., in the SCI.

22. The user device of claim 21, wherein one or more of M, n, k and p may be selected dependent on an application or a use case.

23. The user device of claim 21, wherein the one or more criteria for p are pre-configured or configured for different use cases or applications.

24. The user device of claim 20, wherein the parameter k is selected based on one or more criteria, e.g., a range required to be supported and/or available bits, e.g. in the SCI.

25. The user device of claim 17, wherein the location or position is described as ellipsoid point coordinates, and the one or more location information elements indicate one or more of a latitude, a longitude, an altitude with or without an uncertainty range.

26. The user device of claim 1, wherein the certain area comprises a predefined zone, e.g., a certain zone of a coverage area of a cell, or a certain zone of a part of or all of the coverage of the wireless communication system, or a certain zone within a geographical area covering part or all of the global area.

27. The user device of claim 26, wherein
the zone is associated with a zone ID,
the first part of the location information element comprises the zone ID, and
the second part of the location information element comprises the position of the further UE within the zone.

28. The user device of claim 27, wherein the second part of the location information element defines an offset of the further UE from a reference point or location in the zone, e.g., from an origin in each zone commonly known in the system.

29. A user device, UE, for a wireless communication system, the wireless communication system comprising a plurality of user devices, UEs,
wherein the UE is to communicate with one or more further UEs using a sidelink, SL,
wherein, when being in the certain zone, the UE is to
receive from a further UE located in the same zone or in a different zone, e.g., using sidelink control information, SCI, a zone ID and location information of the further UE, the location information indicating the position of the further UE within the zone in which the further UE is located, and
acquire the location or position of the further UE using the location of the UE and the received zone ID and location information of the further UE.

30. A user device, UE, for a wireless communication system, the wireless communication system comprising a plurality of user devices, UEs,
wherein the UE is to communicate with one or more further UEs using a sidelink, SL,
wherein, when being in the certain zone, the UE is to transmit to a further UE located in the same zone or in a different zone, e.g., using sidelink control information, SCI, a zone ID and location information of the UE, the location information indicating the position of the UE within the certain zone.

31. The user device of claim 29, wherein the certain zone comprises
a certain zone of a coverage area of a cell, or
a certain zone of a part of or all of the coverage of the wireless communication system, or
a certain zone within a geographical area covering part or all of the global area.

32. The user device of claim 29, wherein the location information defines an offset of the UE from a reference point or location in the zone, e.g., from an origin in the zone commonly known in the system.

33. The user device of claim 32, wherein UE knows the reference points or locations of the respective zones.

34. A user device, UE, for a wireless communication system, the wireless communication system comprising a plurality of user devices, UEs,
wherein the UE is to communicate with one or more further UEs using a sidelink,
wherein one or more location information elements describe a location or position of a UE, and
wherein, when being in a certain area, the UE is to
receive at a certain time, e.g., when setting up the SL communication, from the further UE the one or more location information elements comprising the location information of the further UE, and
receive at one or more times following the certain time from the further UE further location information indicating a difference between a current location of the further UE and the location signaled at the certain time.

35. A user device, UE, for a wireless communication system, the wireless communication system comprising a plurality of user devices, UEs,
wherein the UE is to communicate with one or more further UEs using a sidelink,
wherein one or more location information elements describe a location or position of a UE, and
wherein, when being in a certain area, the UE is to
transmit at a certain time, e.g., when setting up the SL communication, to the further UE the one or more location information elements comprising the location information of the UE, and
transmit at one or more times following the certain time to the further UE further location information indicating a difference between a current location of the UE and the location signaled at the certain time.

36. The user device of claim 34, wherein the UE is a receiving UE or a transmitting UE in the SL communication.

37. The user device of claim 34, wherein the one or more location information elements are provided over RRC or over-the-top, OTT, or another type of semi-static signaling, and/or the further location information are provided in or as part of the side link control information, SCI.

38. The user device of claim 37, wherein the one or more location information elements are provided using a unicast RRC message, a multicast RRC message or a group RRC message.

39. The user device of claim 34, wherein the UE and one or more of the further UEs form a group, and wherein the UE is to
transmit to the group UEs the one or more location information elements using respective unicast RRC messages or a group RRC message, and
transmit to the group UEs the further location information using a SCI multicast message comprising, e.g., only the location changes, like a position delta.

40. The user device of claim 39, wherein, in case the one or more location information elements are transmitted to the group UEs using respective unicast RRC messages, the further location information is selected so as to minimize a certain error metric, e.g., a minimum mean square error, MMSE.

41. The user device of claim 1, wherein the one or more location information elements further comprise one or more of:
a current height or altitude of the UE, e.g. for flying UEs such as UAVs, drones, helicopters, planes, and
a motion vector or direction of motion of the UE, e.g., to refine the positioning information.

42. The user device of claim 1, wherein the UE comprise one or more of
a mobile terminal, or
stationary terminal, or
cellular IoT-UE, or
vehicular UE, or
vehicular group leader (GL) UE
an IoT or narrowband IoT, NB-IoT, device, or
a ground based vehicle, or
an aerial vehicle, or
a drone, or
a moving base station, or
road side unit (RSU), or
a building, or
any other item or device provided with network connectivity enabling the item/device to communicate using the wireless communication network, e.g., a sensor or actuator, or
any other item or device provided with network connectivity enabling the item/device to communicate using a sidelink the wireless communication network, e.g., a sensor or actuator, or
any sidelink capable network entity.

43. A wireless communication system, comprising a plurality of user devices, UEs, of claim 1 and configured for a sidelink communication using, for example resources from a set of sidelink resources of the wireless communication system.

44. The wireless communication system of claim 43, comprising one or more base stations, wherein the base station comprises one or more of
a macro cell base station, or
a small cell base station, or
a central unit of a base station, or
a distributed unit of a base station, or
a road side unit (RSU), or
a UE, or
a group leader (GL)
a relay or
a remote radio head, or
an AMF, or
an SMF, or
a core network entity, or
mobile edge computing (MEC) entity, or
a network slice as in the NR or 5G core context, or
any transmission/reception point, TRP, enabling an item or a device to communicate using the wireless communication network, the item or device being provided with network connectivity to communicate using the wireless communication network.

45. A method for acquiring a location or position of a user device, UE in a wireless communication, the wireless communication system comprising a plurality of user devices, UEs, the method comprising:
performing a communicating among a UE and one or more further UEs using a sidelink, SL, wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE,
receiving from the further UE, e.g., using sidelink control information, SCI, position information of the further UE, the position information comprising some or all of the second part of the location information element of the further UE, and
acquiring the location or position of the further UE by combining the one of the set of fixed first parts with the position information which is received from the further UE, wherein, in case the set of fixed first parts comprises more than one fixed first part, the UE is to select the one of the set of fixed first parts using the position information which is received from the further UE.

46. A method for providing a location or position of a user device, UE in a wireless communication, the wireless communication system comprising a plurality of user devices, UEs, the method comprising:
performing a communicating among a UE and one or more further UEs using a sidelink, SL, wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE, and
transmitting from the UE to a further UE, e.g., using sidelink control information, SCI, position information of the UE, the position information comprising some or all of the second part of the location information element of the UE.

47. A method for acquiring a location or position of a user device, UE in a wireless communication, the wireless communication system comprising a plurality of user devices, UEs, the method comprising:
performing a communicating among a UE and one or more further UEs using a sidelink, SL,
receiving from a further UE located in the same zone or in a different zone, e.g., using sidelink control information, SCI, a zone ID and location information of the further UE, the location information indicating the position of the further UE within the zone in which the further UE is located, and
acquiring the location or position of the further UE using the location of the UE and the received zone ID and location information of the further UE.

48. A method for providing a location or position of a user device, UE in a wireless communication, the wireless communication system comprising a plurality of user devices, UEs, the method comprising:
performing a communicating among a UE and one or more further UEs using a sidelink, SL,
when being in a certain zone, transmitting from the UE to a further UE located in the same zone or in a different zone, e.g., using sidelink control information, SCI, a zone ID and location information of the UE, the location information indicating the position of the UE within the certain zone.

49. A method for providing a location or position of a user device, UE in a wireless communication, the wireless communication system comprising a plurality of user devices, UEs, the method comprising:
performing a communicating among a UE and one or more further UEs using a sidelink, SL, wherein one or more location information elements describe a location or position of a UE,
receiving at a certain time, e.g., when setting up the SL communication, from the further UE the one or more location information elements comprising the location information of the further UE, and
receiving at one or more times following the certain time from the further UE further location information indicating a difference between a current location of the further UE and the location signaled at the certain time.

50. A method for providing a location or position of a user device, UE in a wireless communication, the wireless communication system comprising a plurality of user devices, UEs, the method comprising:
performing a communicating among a UE and one or more further UEs using a sidelink, SL, wherein one or more location information elements describe a location or position of a UE, and
transmitting at a certain time, e.g., when setting up the SL communication, to the further UE the one or more location information elements comprising the location information of the UE, and
transmitting at one or more times following the certain time to the further UE further location information indicating a difference between a current location of the UE and the location signaled at the certain time.

51. A non-transitory digital storage medium having a computer program stored thereon to perform the method for acquiring a location or position of a user device, UE in a wireless communication, the wireless communication system comprising a plurality of user devices, UEs, the method comprising:
performing a communicating among a UE and one or more further UEs using a sidelink, SL, wherein one or more location information elements describe a location or position of a UE, wherein the location information element comprises a first part and a second part, wherein, for locations or positions within a certain area, the first part of the location information element is one of a set of fixed first parts and the second part of the location information element varies dependent on the actual or exact location or position of the UE,
receiving from the further UE, e.g., using sidelink control information, SCI, position information of the further UE, the position information comprising some or all of the second part of the location information element of the further UE, and
acquiring the location or position of the further UE by combining the one of the set of fixed first parts with the position information which is received from the further UE, wherein, in case the set of fixed first parts comprises more than one fixed first part, the UE is to select the one of the set of fixed first parts using the position information which is received from the further UE,
when said computer program is run by a computer.
